(19) United States
(12) Patent Application Publication
(10) Pub. No.: US 2025/0258049 A1
(43) Pub. Date: Aug. 14, 2025

(54) METAMATERIAL MEASUREMENT FOR INCREASED MEASUREMENT RANGE AND INCREASED RESOLUTION

(71) Applicant: Infineon Technologies AG, Neubiberg (DE)

(72) Inventors: Dirk HAMMERSCHMIDT, Finkenstein (AT); Christof MICHENTHALER, Feistritz an der Gail (AT)

(21) Appl. No.: 18/440,531

(22) Filed: Feb. 13, 2024

(51) Int. Cl. G01L 3/10

(52) U.S. Cl. CPC G01L 3/101

(57) ABSTRACT

A measurement system includes a first pair and a second pair of metamaterial arrays respectively configured to rotate about a rotational axis. The first pair of metamaterial arrays are mutually coupled to each other by a first torque-dependent coupling, thereby forming a first mutually coupled structure. The second pair of metamaterial arrays are mutually coupled to each other by a second torque-dependent coupling, thereby forming a second mutually coupled structure. In response to a torque applied to the rotational shaft, metamaterial arrays of the first pair of metamaterial arrays are configured to undergo a first rotational shift relative to each other, and metamaterial arrays of the second pair of metamaterial arrays are configured to undergo a second rotational shift relative to each other. A change in the first torque-dependent coupling caused by the torque is different than a change in the second torque-dependent coupling caused by the same torque.

### BACKGROUND

Vehicles feature numerous safety, body, and powertrain applications that rely on speed sensing, position sensing, and/or angle sensing, as well as torque measurements. For example, in a vehicle's Electronic Stability Program (ESP), magnetic angle sensors and linear Hall sensors can be used to measure steering angle and steering torque. Modern powertrain systems can rely on magnetic speed sensors for camshaft, crankshaft, and transmission applications, along with automotive pressure sensors, to achieve required CO₂ targets and smart powertrain solutions.

### SUMMARY

In some implementations, a torque measurement system includes a first pair of metamaterial arrays arranged at least partially around a rotational axis of a rotational shaft, wherein the first pair of metamaterial arrays are coupled to the rotational shaft and are configured to rotate about the rotational axis, wherein metamaterial arrays of the first pair of metamaterial arrays are mutually coupled to each other by a first torque-dependent coupling, thereby forming a first mutually coupled structure; and a second pair of metamaterial arrays arranged at least partially around the rotational axis of the rotational shaft, wherein the second pair of metamaterial arrays are coupled to the rotational shaft and are configured to rotate about the rotational axis, wherein metamaterial arrays of the second pair of metamaterial arrays are mutually coupled to each other by a second torque-dependent coupling, thereby forming a second mutually coupled structure, wherein, in response to a torque applied to the rotational shaft, the metamaterial arrays of the first pair of metamaterial arrays are configured to undergo a first rotational shift relative to each other, and the metamaterial arrays of the second pair of metamaterial arrays are configured to undergo a second rotational shift relative to each other, and wherein a change in the first torque-dependent coupling caused by the torque is different than a change in the second torque-dependent coupling caused by the torque.

In some implementations, a measurement system includes a first metamaterial array coupled to a first carrier structure, the first metamaterial array comprising first elementary structures; a second metamaterial array coupled to a second carrier structure, the second metamaterial array comprising second elementary structures, wherein the first metamaterial array and the second metamaterial array are mutually coupled to each other by a first shift-dependent coupling, thereby forming a first mutually coupled structure; a third metamaterial array coupled to the first carrier structure, the third metamaterial array comprising third elementary structures; and a fourth metamaterial array coupled to the second carrier structure, the fourth metamaterial array comprising fourth elementary structures, wherein the third metamaterial array and the fourth metamaterial array are mutually coupled to each other by a second shift-dependent coupling, thereby forming a second mutually coupled structure, wherein the first carrier structure and the second carrier structure are configured to allow a relative shift between the first carrier structure and the second carrier structure such that the first metamaterial array and the second metamaterial array undergo a first positional shift relative to each other, and the third metamaterial array and the fourth metamaterial array undergo a second positional shift relative to each other, and wherein a change in the first shift-dependent coupling caused by the relative shift between the first carrier structure and the second carrier structure is different than a change in the second shift-dependent coupling caused by the relative shift between the first carrier structure and the second carrier structure.

In some implementations, a method of determining a relative shift between a first carrier structure and a second carrier structure of a mechanical system includes inducing a first positional shift between a first metamaterial array coupled to the first carrier structure and a second metamaterial array coupled to the second carrier structure in response to the relative shift between the first carrier structure and the second carrier structure inducing a second positional shift between a third metamaterial array coupled to the first carrier structure and a fourth metamaterial array coupled to the second carrier structure in response to the relative shift between the first carrier structure and the second carrier structure, wherein the first metamaterial array and the second metamaterial array are mutually coupled to each other by a first shift-dependent coupling, thereby forming a first mutually coupled structure, wherein the third metamaterial array and the fourth metamaterial array are mutually coupled to each other by a second shift-dependent coupling, thereby forming a second mutually coupled structure, and wherein a change in the first shift-dependent coupling caused by the relative shift between the first carrier structure and the second carrier structure is different than a change in the second shift-dependent coupling caused by the relative shift between the first carrier structure and the second carrier structure; transmitting at least one electromagnetic transmit wave during the relative shift to generate a first electromagnetic receive wave by the first mutually coupled structure and a second electromagnetic receive wave by the first mutually coupled structure; and determining the relative shift between the first carrier structure and the second carrier structure based on at least one of the first electromagnetic receive wave or the second electromagnetic receive wave.

### BRIEF DESCRIPTION OF THE DRAWINGS

Implementations are described herein making reference to the appended drawings.

FIG. 1 illustrates example elementary structures according to one or more implementations.

FIGS. 2A and 2B illustrate segments of example metamaterial tracks according to one or more implementations.

FIG. 3A is a schematic view of a torque measurement system according to one or more implementations.

FIG. 3B is a schematic view of a torque measurement system according to one or more embodiments.

FIG. 4 illustrates an example transceiver circuit of a transceiver according to one or more implementations.

FIG. 5A illustrates a diagram showing a front view of two overlapping pairs of metamaterial arrays in response to an applied torque.

FIG. 5B illustrates a diagram showing a front view of two overlapping pairs of metamaterial arrays in response to an applied torque.

FIG. 5C illustrates a diagram showing a front view of two overlapping pairs of metamaterial arrays.

FIG. 5D illustrates a diagram showing a front view of two overlapping pairs of metamaterial arrays.

FIG. 5E illustrates a diagram showing a front view of two overlapping pairs of metamaterial arrays.

FIG. 5F illustrates a diagram showing a front view of two overlapping pairs of metamaterial arrays.

FIG. 6 illustrates an example of measurement signal diagrams according to one or more implementations.

### DETAILED DESCRIPTION

In the following, details are set forth to provide a more thorough explanation of example implementations. However, it will be apparent to those skilled in the art that these implementations may be practiced without these specific details. In other instances, well-known structures and devices are shown in block diagram form or in a schematic view rather than in detail in order to avoid obscuring the implementations. In addition, features of the different implementations described hereinafter may be combined with each other, unless specifically noted otherwise.

Further, equivalent or like elements or elements with equivalent or like functionality are denoted in the following description with equivalent or like reference numerals. As the same or functionally equivalent elements are given the same reference numbers in the figures, a repeated description for elements provided with the same reference numbers may be omitted. Hence, descriptions provided for elements having the same or like reference numbers are mutually exchangeable.

Each of the illustrated x-axis, y-axis, and z-axis is substantially perpendicular to the other two axes. In other words, the x-axis is substantially perpendicular to the y-axis and the z-axis, the y-axis is substantially perpendicular to the x-axis and the z-axis, and the z-axis is substantially perpendicular to the x-axis and the y-axis. In some cases, a single reference number is shown to refer to a surface, or fewer than all instances of a part may be labeled with all surfaces of that part. All instances of the part may include associated surfaces of that part despite not every surface being labeled.

The orientations of the various elements in the figures are shown as examples, and the illustrated examples may be rotated relative to the depicted orientations. The descriptions provided herein, and the claims that follow, pertain to any structures that have the described relationships between various features, regardless of whether the structures are in the particular orientation of the drawings, or are rotated relative to such orientation. Similarly, spatially relative terms, such as “top,” “bottom,” “below,” “beneath,” “lower,” “above,” “upper,” “middle,” “left,” and “right,” are used herein for ease of description to describe one element's relationship to one or more other elements as illustrated in the figures. The spatially relative terms are intended to encompass different orientations of the element, structure, and/or assembly in use or operation in addition to the orientations depicted in the figures. A structure and/or assembly may be otherwise oriented (rotated 90 degrees or at other orientations), and the spatially relative descriptors used herein may be interpreted accordingly. Furthermore, the cross-sectional views in the figures only show features within the planes of the cross-sections, and do not show materials behind the planes of the cross-sections, unless indicated otherwise, in order to simplify the drawings.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

In implementations described herein or shown in the drawings, any direct electrical connection or coupling, e.g., any connection or coupling without additional intervening elements, may also be implemented by an indirect connection or coupling, e.g., a connection or coupling with one or more additional intervening elements, or vice versa, as long as the general purpose of the connection or coupling, for example, to transmit a certain kind of signal or to transmit a certain kind of information, is essentially maintained. Features from different implementations may be combined to form further implementations. For example, variations or modifications described with respect to one of the implementations may also be applicable to other implementations unless noted to the contrary.

As used herein, the terms “substantially” and “approximately” mean “within reasonable tolerances of manufacturing and measurement.” For example, the terms “substantially” and “approximately” may be used herein to account for small manufacturing tolerances or other factors (e.g., within 5%) that are deemed acceptable in the industry without departing from the aspects of the implementations described herein. For example, a resistor with an approximate resistance value may practically have a resistance within 5% of the approximate resistance value. As another example, an approximate signal value may practically have a signal value within 5% of the approximate signal value.

In the present disclosure, expressions including ordinal numbers, such as “first”, “second”, and/or the like, may modify various elements. However, such elements are not limited by the above expressions. For example, the above expressions do not limit the sequence and/or importance of the elements. The above expressions are used merely for the purpose of distinguishing an element from the other elements. For example, a first box and a second box indicate different boxes, although both are boxes. For further example, a first element could be termed a second element, and similarly, a second element could also be termed a first element without departing from the scope of the present disclosure.

Magnetic sensors may be used for speed sensing, position sensing, angle sensing, and/or torque sensing in various applications. However, a disadvantage of using magnetic sensors for speed sensing, position sensing, and/or angle sensing is that they are sensitive to magnetic disturbances. Magnetic disturbance fields are prevalent in vehicles such that magnetic measurements often have to endure harsh environments. This is especially problematic in hybrid and electric vehicles, where many wires and current rails carrying high currents can be located near a magnetic sensor system. Thus, magnetic disturbance fields generated by these high currents may influence the accuracy of magnetic measurements obtained by a magnetic sensor for speed sensing, position sensing, and/or angle sensing.

Alternatively, a torque sensor may use electromagnetic waves to perform a torque measurement using metamaterial targets for contactless sensor readout. The torque sensor may rely on two metamaterial tracks that are spaced apart by a lateral distance and are mutually coupled to each other by a torque-dependent coupling, such as a capacitive field coupling and/or an inductive field coupling. For example, a first metamaterial track may be coupled to and configured to co-rotate with a first rotatable carrier structure, and a second metamaterial track may be coupled to and configured to co-rotate with a second rotatable carrier structure. When a torque is applied, the first and second metamaterial tracks may undergo a torque-dependent rotational shift relative to each other. In other words, the two metamaterial tracks may rotate by different amounts, causing a rotational shift between the two metamaterial tracks that is dependent on the torque. The torque-dependent rotational shift may be measured using electromagnetic waves directed at the two metamaterial tracks and translated into a torque measurement.

However, a resolution of a measurement and an unambiguous measurement range of the torque-dependent rotational shift are typically tradeoffs. The unambiguous measurement range may correspond to a range of torque, from zero to an upper limit, through which torque can be determined unambiguously. Exceeding the upper limit may produce an ambiguous measurement of the torque. The two metamaterial tracks may provide high-resolution measurements, but with a small unambiguous range of the torque-dependent rotational shift. In contrast, the two metamaterial tracks may provide a large unambiguous range of the torque-dependent rotational shift, but with a low-resolution.

Some implementations disclosed herein are directed to an electromagnetic wave sensor and mm-wave systems that include two pairs of metamaterial arrays with different measurement resolutions and different unambiguous measurement ranges. For example, in response to a torque applied to a rotational shaft, metamaterial arrays of a first pair of metamaterial arrays are configured to undergo a first rotational shift relative to each other, and metamaterial arrays of a second pair of metamaterial arrays are configured to undergo a second rotational shift relative to each other, with a change in the a torque-dependent coupling of the first pair of metamaterial arrays caused by the torque is different than a change in a second torque-dependent coupling of the second pair of metamaterial arrays caused by the same torque. Thus, a measurement system may select between the two pairs of metamaterial arrays to obtain a desired measurement resolution and unambiguous measurement range for measuring a torque. Alternatively, the two pairs of metamaterial arrays may be used in combination to measure the torque.

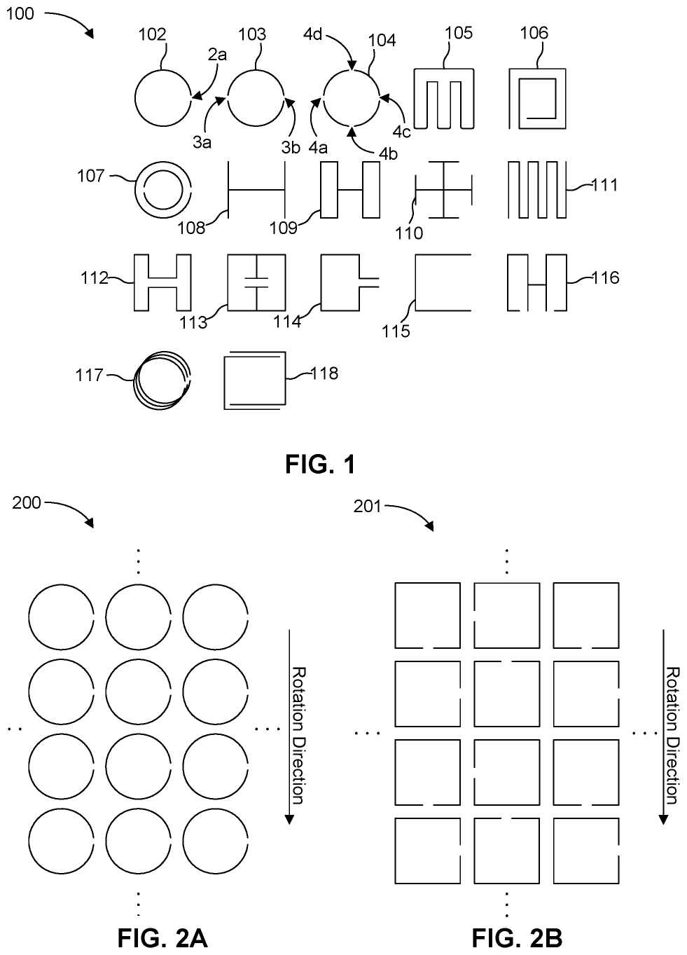

FIG. 1 illustrates example elementary structures 100 according to one or more implementations. The elementary structures 100 include a split ring resonator 102 having one capacitor coupling 2a, a split ring resonator 103 having two capacitor couplings 3a and 3b, a split ring resonator 104 having four capacitor couplings 4a-4d, an antenna structure 105, an antenna coil 106, a nested split ring resonator 107, an antenna structure 108, an antenna structure 109, an antenna structure 110, a transmission line structure 111, an antenna structure 112, a coupled split ring resonator 113, a split ring resonator 114, a partial ring or coupling structure 115, a coupled split ring resonator 116, a stacked split ring resonator structure 117, and a split ring resonator 118. In some implementations, the elementary structures may be sensitive to mm-waves.

Mm-waves are radio waves designated in the band of radio frequencies in the electromagnetic spectrum from 30 to 300 gigahertz (GHz), and may also be used as radar waves. Thus, a mm-wave sensor, system, transmitter, receiver, or transceiver described herein may also be regarded as a radar sensor, system, transmitter, receiver, or transceiver, and a mm-wave may be regarded as a radar signal. However, some implementations may also be applied in applications different from radar, such as radio frequency (RF) transmitters, receivers, or transceivers of RF devices. In fact, any RF circuitry may take advantage of the concepts described herein. A mm-wave sensor or mm-wave system may be configured, for example, as an angle sensor, a rotary position sensor, a linear position sensor, a speed sensor, a motion sensor, and/or a torque sensor.

A metamaterial is a material engineered to have a property that is not found in naturally occurring materials. The metamaterial is made from assemblies of multiple structural elements, also referred to as elementary structures, fashioned from composite materials such as metals or plastics. The structural elements may be arranged in repeating or periodic patterns, at scales that are smaller than the wavelengths of a phenomenon that the structural elements influence. In other words, metamaterials attain desired effects by incorporating structural elements of sub-wavelength sizes (e.g., features which are actually smaller than the wavelength of the electromagnetic waves that the structural elements affect).

As a result, metamaterials derive their properties not necessarily from the properties of the base materials, but from their designed structural elements. The precise shape, geometry, size, orientation, and arrangement of the structural elements gives the metamaterials their smart properties capable of manipulating electromagnetic waves (e.g., by blocking, reflecting, absorbing, enhancing, or bending waves) to achieve benefits. Thus, a metamaterial is an artificial composite that gains its electrical properties from its exactingly-designed structural elements and the arrangement of the structural elements relative to each other, rather than directly from materials of which the metamaterial is composed.

A metamaterial may be a subset of a larger group of heterogeneous structures composed of a base solid material and structural elements of a different material. The distinction of metamaterials is that they have special, sometimes anomalous, properties over a limited frequency band. For example, mm-wave metamaterials may exhibit special properties over a millimeter band of spectrum between 30 GHz and 300 GHz, as noted above.

In the context of the described implementations, a metamaterial is a 2D or three-dimensional (3D) array of elementary structures, which are coupled to each other. “Elementary structures,” as used herein, may refer to discrete structures, element structures, or discrete element structures. In some cases, the elementary structures may be referred to simply as “structures.” Elementary structures themselves may be composed of one or more conductive elements. When an elementary structure is composed of two or more conductive elements, the conductive elements may be mutually coupled to each other by, for example, a capacitive coupling, an inductive coupling, or a galvanic coupling. Additionally, the conductive elements of adjacent elementary structures may be mutually coupled to each other by, for example, a capacitive coupling, an inductive coupling, or a galvanic coupling.

The overall array of elementary structures provides macroscopic properties, which can be configured by the elementary structures used and their coupling paths. Metamaterials are configured for different kinds of waves like electromagnetic waves (e.g., optical, infrared (IR), and mm-waves) and mechanical waves (e.g., ultrasonic). The elementary structures and their grid pitch scale with the wavelength of a target frequency range (e.g., target frequency band).

Elementary structures in mm-wave metamaterials may include resonator elements, antenna elements, filter elements, waveguide elements, transmission line elements, or a combination thereof. An elementary structure size may range up to several wavelengths but is typically below one wavelength of a target frequency. Elementary structures may include parts that generate magnetic fields (e.g., conductor rings) and other parts that create electrical fields (e.g., gaps between conductors). Furthermore, elementary structure may also have elements that have electromagnetic wave properties, such as a short transmission line segment.

In general, elementary structures may electrically represent resistive-inductive-capacitive (RLC) networks. In a frequency range in which the elementary structures will be used, a characteristic of their resistive, inductive, and capacitive parameters is distributed over the geometry of the metamaterial. Since filters, resonators, transmission lines, and antennas can be differently-parametrized representatives of identical structures, it is often not possible to unambiguously assign a structure to a single group. Thus, it is to be understood that a structure described as a resonator can also be seen as antenna or a filter, depending on its use or implementation details. Furthermore, the behavior of a structure may also change with the frequency where it is operated, and a structure that behaves as a transmission line for one frequency may also expose a filter characteristic or create a resonance at another frequency of operation. Finally, the choice of the material impacts the behavior, which means that a choice of a better conductor will emphasize a resonant behavior, while a less conductive material will increase damping and make a filter characteristic dominant.

The transmission line structure 111 may be a damping structure or a delay structure. It may be used in an alternating configuration with resonators in order to establish an attenuated or phase-shifted coupling between the elementary structures instead of coupling directly. Coupling to the resonators can be capacitive or galvanic. The transmission line structure 111 may also extend onto a second layer, for example, with an identical structure creating a transmission line (e.g., two parallel wires).

The partial ring or coupling structure 115 may be referred to as a partial ring structure in the context of it being half of the split ring resonator 118. In this context, the partial ring structure 115 may be coupled to a second layer to form a resonator.

The elementary structures can be three-dimensional, such as spiral coils and nested split ring resonators that are oriented into all three Cartesian coordinate directions. Furthermore, three-dimensional structures can be generated by layering two-dimensional elementary structures in a stacked arrangement. For example, two elementary structures may be layered over one another in a vertical dimension so that they overlap with each other. In this way, a vertical capacitive coupling may be achieved between the two elementary structures and may be adjusted by varying an amount of overlap in a horizontal dimension.

The stacked split ring resonator structure 117 may have three split ring resonators stacked on top of each other. In some implementations, the stacked split ring resonator structure 117 may be formed by using three metallization layers stacked on top of each other.

The split ring resonator 118 may be made of two partial ring structures 115 that overlap, such that a vertical capacitive coupling exists between the two partial ring structures. By varying the amount of overlap, the loop size can be made larger (e.g., by decreasing the amount of overlap) or smaller (e.g., by increasing the amount of overlap), which in turn results in a lower vertical capacitive coupling or a higher vertical capacitive coupling, respectively.

In order to achieve a quasi-homogeneous macroscopic behavior, the elementary structures may be arranged in a 2D metamaterial array that may have dimensions that are larger than a wavelength of the target frequency range and include a plurality of elementary structures in each direction of the 2D metamaterial array.

As indicated above, FIG. 1 is provided as an example. Other examples may differ from what is described with regard to FIG. 1.

FIGS. 2A and 2B illustrate segments of example metamaterial tracks according to one or more implementations. A metamaterial track may be a strip of metamaterial that has elementary structures arranged in both widthwise (axial) and lengthwise (e.g., rotational or circumferential) dimensions of a polar coordinate system. Here, the direction orthogonal to a rotation direction may be referred to as an axial direction. The metamaterial track may be sensitive to a target frequency (e.g., resonance frequency) or a target frequency range (e.g., a resonance frequency range) of electromagnetic waves. For example, the metamaterial track may be a mm-wave metamaterial track that is sensitive to mm-waves.

For example, FIG. 2A shows an example of a 2D array 200 of split ring resonators, which are expected to extend further in both axial and rotation (e.g., circumferential) directions. However, it will be appreciated that the split ring resonators may be exchanged with any type of elementary structure (for example, with any of those shown in FIG. 1). Each split ring resonator comprises an open ring that represents an inductivity (L) and a gap or opening that provides a capacitive coupling (C). Thus, each split ring resonator may be a type of LC resonator.

The elementary structures that make up the segment of a metamaterial track shown in FIG. 2A may have a fixed arrangement or fixed property along the rotation direction. For example, the split ring resonators in each row may be arranged in the same position and orientation. Furthermore, the spacing between adjacent split ring resonators in the rotation direction may be fixed along the track. Accordingly, in some implementations, the 2D array 200 may not have any change in property of the elementary structures along the metamaterial track in the rotation direction. However, in some implementations, one or more properties between the elementary structures, such as spacing or orientation, may change in the axial direction and/or in the rotation direction.

There exists a mutual coupling of the elementary structures in the 2D array 200, which can be a capacitive coupling, an inductive coupling, or both. Here, both types of coupling are present in the 2D array 200. For example, capacitive coupling between the elementary structures exists in the vertical direction (e.g., along the rotation direction) on the sides where rings are close together. In addition, inductive coupling between the elementary structures is provided by a field generated by each split ring resonator.

Thus, electrically, the arrangement of the elementary structures in an array introduces a mutual coupling between the elementary structures, wherein the mutual coupling may include electric field coupling (e.g., capacitive near-field coupling), magnetic field coupling (e.g., inductive near-field coupling), waveguide coupling, or electromagnetic wave coupling (e.g., far-field coupling). Due to the dimensions of the arrays and depending on the type of elementary structures used, the coupling effect will typically be made up of a mixture of all mechanisms. The manner in which the structures are mutually coupled affects a coupling effect of the 2D array 200 or a portion of the 2D array 200. In turn, this coupling effect impacts an effect that individual elementary structures or a group of elementary structures have on an electromagnetic wave or signal that is incident on the elementary structure or the group of elementary structures. For example, the elementary structures of the metamaterial track may have a mm-wave property that affects a manner in which the elementary structures interact with a mm-wave. When an elementary structure or a group of elementary structures interacts with an initial mm-wave, the elementary structure or the group of elementary structures may cause the initial mm-wave to be converted, for example, by reflection and/or absorption, into a converted mm-wave that has a measurable property (e.g., a parameter value) that corresponds to a metamaterial characteristic of the elementary structure or the group of elementary structures. By way of example, the converted mm-wave may have an amplitude, a phase, or a frequency that corresponds to the metamaterial characteristic of the elementary structure or the group of elementary structures. In other words, the converted mm-wave may undergo a change in amplitude, phase, and/or frequency, relative to the initial mm-wave, that corresponds to the metamaterial characteristic of the elementary structure or the group of elementary structures that interact with the initial mm-wave. Thus, different coupling effects of the elementary structures may produce converted mm-waves having different values (e.g., a parameter values) of the measurable property.

Furthermore, the coupling effect between elementary structures may be different if gaps or openings of neighboring elementary structures are face-to-face, or if the gaps face (e.g., are adjacent to) a closed segment of a neighboring elementary structure. For example, FIG. 2B shows an example of 2D array 201 of split ring resonators in which an orientation of the split ring resonators changes in both the horizontal (width) and vertical (length) directions of the 2D array 201 (e.g., of the metamaterial track). In other words, the locations of the gaps of the split ring resonators may vary across neighboring elementary structures, and the rows of elementary structures may have different patterns. Here, while not required, each row of elementary structures may have a unique pattern. As a result, the coupling effect between the elementary structures in FIG. 2B may be different than the coupling effect produced by the elementary structures shown in FIG. 2A.

Furthermore, the coupling effect between structures in FIG. 2B changes partially along the 2D array 201 in the rotation direction, whereas the coupling effect between the elementary structures in FIG. 2A does not change along the array in the rotation direction. The different shapes (circular versus rectangular) may also impact the characteristic of the structure itself and the coupling effect.

Each elementary structure may have a size (e.g., a width or diameter) of, for example, 10% to 100% of the wavelength of a transmitted electromagnetic wave to which the structure is sensitive. The 2D array 200 may be a single metallization layer disposed or printed on a film such that the 2D array 200 is two-dimensional. As noted above, multiple metallization layers may be stacked to form a 3D array.

Thus, arrays of elementary structures described herein include multiple repetitions of elementary structures having the same or differing arrangements with respect to each other that induce a property on a transmitted electromagnetic wave or signal incident thereon due to the coupling effect between the elementary structures.

A metamaterial track may be coupled to a target object (e.g., a rotatable carrier structure) such that the metamaterial track is arranged at least partly around a rotational axis. In some implementations, the metamaterial track may form a closed loop around the rotational axis, thereby forming a 360° periodical pattern. The elementary structures of the metamaterial track may have a 360° periodical pattern that may or may not change continuously around the circumference of the rotatable carrier structure and/or along a perimeter of the metamaterial track. For example, a metamaterial track used for a direct torque measurement may not have any change in property of the elementary structures along the metamaterial track in the rotation direction, such as the case for the 2D array 200. In contrast, metamaterial tracks used for an angle measurement, a rotational position change, or an indirect torque measurement may have a change in property of the elementary structures along the elementary track in the rotation direction. If the pattern of the elementary structures changes along the rotation direction, the pattern may change by continuously changing from 0° to 360° along the rotation direction of the metamaterial track, and then repeat.

There are diverse possibilities for changing a metamaterial property according to a 360° periodical pattern. It will also be appreciated that a rotational segment of less than 360° may also be applicable. For example, applications that measure limited angle ranges (e.g., a throttle valve, a chassis level, or a gas pedal) may also be used. In these cases, the pattern of the elementary structures need not be 360° periodic and may instead change over a smaller angular range (e.g., 45°, 60°, 90°, 180°, etc.). It naturally follows that the rotatable carrier structure also does not need to be a complete disc and can be a partial disc or an angular segment.

A property and/or arrangement of the metamaterial may be specific to an absolute angular position along the metamaterial track. Thus, in some implementations, the property of the metamaterial along the metamaterial track may also be specific to an absolute angular position of the rotatable carrier structure. An absolute angular position is an angular position relative to a reference (e.g., predetermined) angular position of the rotatable carrier structure. For example, the reference angular position may be zero degrees, and an absolute angular position may a specific angular position rotated from zero degrees over a 360° period. Thus, each absolute angular position has an absolute angular value from 0° to 360°.

As indicated above, FIGS. 2A and 2B are provided as examples. Other examples may differ from what is described with regard to FIGS. 2A and 2B.

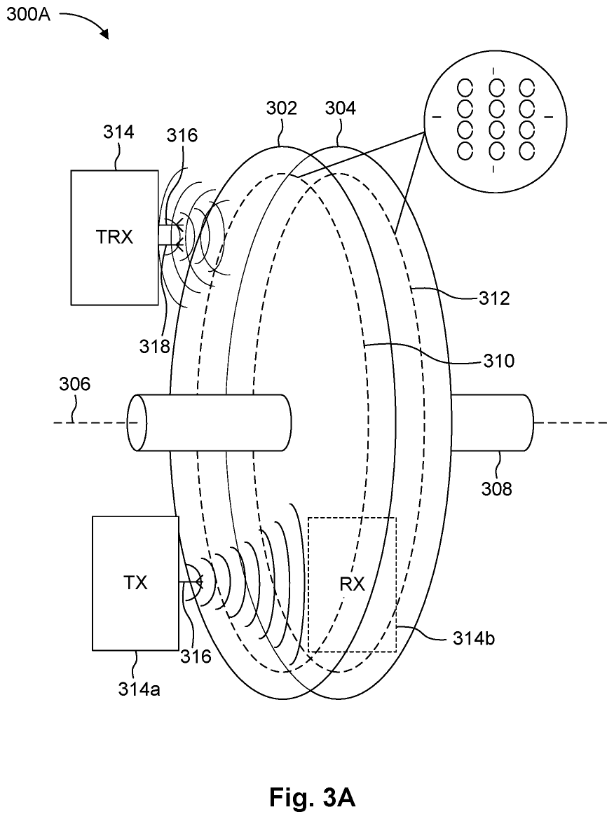

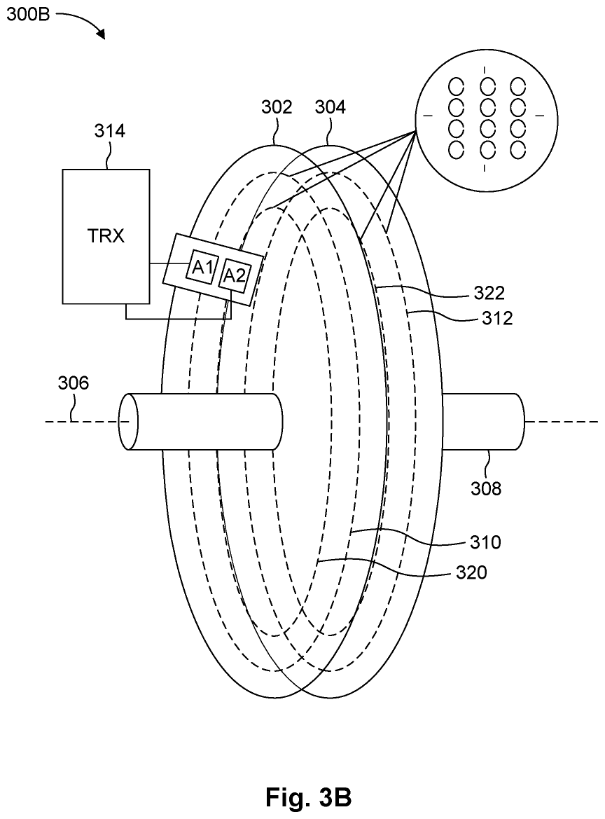

FIG. 3A is a schematic view of a torque measurement system 300A according to one or more implementations. The torque measurement system 300A may include a first rotatable target object as a first rotatable carrier structure 302 and a second rotatable target object as a second rotatable carrier structure 304. The first rotatable carrier structure 302 and the second rotatable carrier structure 304 are configured to rotate about a rotational axis 306. The first rotatable carrier structure 302 and the second rotatable carrier structure 304 may be two discs or two wheels coupled to a rotational shaft 308 that extends in an axial direction along the rotational axis 306. As the rotational shaft 308 rotates, so do the first rotatable carrier structure 302 and the second rotatable carrier structure 304. The first rotatable carrier structure 302 and the second rotatable carrier structure 304 may represent mechanical targets for one or more mm-wave beams. Additionally, the first rotatable carrier structure 302 and the second rotatable carrier structure 304 are laterally separated from each other by a distance along the rotational shaft 308. For example, the first rotatable carrier structure 302 and the second rotatable carrier structure 304 may be laterally spaced apart from each other in a transmission direction (e.g., in the axial direction) of the mm-wave beams by a first defined lateral distance.

The torque measurement system 300A further includes a first metamaterial track 310 (e.g., a mm-wave metamaterial track) coupled to the first rotatable carrier structure 302 as a first metamaterial layer. The first metamaterial track 310 may form a closed loop around the rotational axis 306. The first metamaterial track 310 may be fixed to the first rotatable carrier structure 302 such that first metamaterial track 310 co-rotates with the first rotatable carrier structure 302 as the first rotatable carrier structure 302 rotates.

Additionally, the torque measurement system 300A further includes a second metamaterial track 312 (e.g., a mm-wave metamaterial track) coupled to the second rotatable carrier structure 304 as a second metamaterial layer. The second metamaterial track 312 may form a closed loop around the rotational axis 306. The second metamaterial track 312 may be fixed to the second rotatable carrier structure 304 such that second metamaterial track 312 co-rotates with the second rotatable carrier structure 304 as the second rotatable carrier structure 304 rotates.

The first metamaterial track 310 and the second metamaterial track 312 may have a same size and shape such that the two metamaterial tracks are substantially aligned with each other in the axial direction of the rotational axis 306. Thus, the first metamaterial track 310 and the second metamaterial track 312 are laterally separated by a distance along the rotational shaft 308. For example, the first rotatable carrier structure 302 and the second rotatable carrier structure 304 are laterally spaced apart from each other in the transmission direction (e.g., in the axial direction) of the mm-wave beams by a second defined lateral distance.

According to at least one implementation, the first metamaterial track 310 and the second metamaterial track 312 each have an array of elementary structures whose metamaterial properties do not change in the rotation direction, as explained above in reference to FIG. 2A. In some implementations, the first metamaterial track 310 may be referred to as a first metamaterial array, and the second metamaterial track 312 may be referred to as a second metamaterial array. Furthermore, the first metamaterial track 310 and the second metamaterial track 312 are close enough to each other that the two metamaterial tracks 310 and 312 have a mutual coupling with each other that is induced by a field coupling effect (e.g., an electric field coupling, a magnetic field coupling, or an electromagnetic field coupling). As a result of the field coupling effect, the first metamaterial track 310 and the second metamaterial track 312 may form a resonant multitrack structure (e.g., a mutually coupled structure). The mutual coupling between the first metamaterial track 310 and the second metamaterial track 312 results in a torque-dependent behavior or interaction with a mm-wave, where the torque-dependent behavior or interaction is a torque-dependent reflection, a torque-dependent absorption, a torque-dependent transmission, or a torque-dependent combination of reflection, absorption, and/or transmission. In other words, the first metamaterial track 310 and the second metamaterial track 312 form a pair of metamaterial arrays that are mutually coupled to each other by a torque-dependent coupling, thereby forming a mutually coupled structure. The mutually coupled structure formed by the pair of metamaterial arrays may have a resonance frequency that corresponds to the torque-dependent coupling. A change in the torque-dependent coupling may cause the resonance frequency to change by an amount corresponding to an applied torque.

When torque is applied to the rotational shaft 308, the torque causes the rotational shaft 308 to rotate. In addition, the torque causes a torsional sheer stress within the rotational shaft 308, which causes different portions of the rotational shaft 308 along the rotation axis 306 to undergo a different amount of twisting or rotation. Because the first rotatable carrier structure 302 and the second rotatable carrier structure 304 are coupled to the rotational shaft 308 at different axial or lateral distances, the first rotatable carrier structure 302 and the second rotatable carrier structure 304 undergo different amounts or degrees of rotation. Therefore, when the rotational shaft 308 rotates due to the applied torque, there is a torque-dependent shift in angular position (e.g., an angular shift or a rotational shift) between the first rotatable carrier structure 302 and the second rotatable carrier structure 304. In other words, the first rotatable carrier structure 302 and the second rotatable carrier structure 304 rotate about the rotational shaft 308 by differing amounts based on an amount of torque applied to the rotational shaft 308.

Furthermore, because the first metamaterial track 310 is configured to co-rotate with the first rotatable carrier structure 302, and the second metamaterial track 312 is configured to co-rotate with the second rotatable carrier structure 304, the first metamaterial track 310 and the second metamaterial track 312 undergo the same torque-dependent shift in angular position (e.g., an angular shift or a rotational shift) based on the applied torque. In other words, the first metamaterial track 310 is configured to undergo a rotational shift relative to the second metamaterial track 312 based on the applied torque. This rotational shift results in a torque-dependent shift in the mutual coupling between the first metamaterial track 310 and the second metamaterial track 312. Since multiple metamaterial properties of the mutually coupled metamaterial tracks may change simultaneously in response to the applied torque that causes the rotational shift, multiple mm-wave properties of a mm-wave that is either transmitted, reflected, or emitted by the mutually coupled metamaterial tracks may depend on the applied torque. Two or more mm-wave properties of a same converted mm-wave or of different converted mm-waves may be evaluated to determine the applied torque. Alternatively, a single mm-property of two or more converted mm-waves may be evaluated to determine the applied torque.

In some implementations, the torque measurement system 300A may include a transceiver (TRX) 314 configured to transmit and receive mm-waves. In some implementations, the torque measurement system 300A may include a transmitter 314a and a receiver 314b configured to transmit and receive mm-waves. The transmitter 314a and the receiver 314b may be placed such that the first rotatable carrier structure 302 and the second rotatable carrier structure 304, and thus the first metamaterial track 310 and the second metamaterial track 312, are arranged between the transmitter 314a and the receiver 314b in the axial (lateral) direction.

The transceiver 314 may include a transmitter antenna 316 configured to transmit a mm-wave beam (e.g., an electromagnetic transmit wave) as a wireless electromagnetic wave focused at the first metamaterial track 310 and the second metamaterial track 312 (e.g., at the mutually coupled structure). In the case that a separate transmitter 314a and receiver 314b are used, the transmitter 314a may be equipped with the transmitter antenna 316.

The transceiver 314 may also include a receiver antenna 318 configured to receive a partially-reflected mm-wave (e.g., an electromagnetic receive wave) as a wireless electromagnetic wave from the first metamaterial track 310 and the second metamaterial track 312 (e.g., the mutually coupled structure).

In some implementations, the transmitter antenna 316 of the transceiver 314 may be used as a transmit and receive antenna, and the transceiver 314 may include a splitter (e.g., a rat-race coupler or a hybrid ring coupler) that is configured to separate energy transmission paths of correspond RF signals. The splitter may be configured to direct a received wave from the receiver antenna 318 to receiver circuitry and direct a transmit signal from transmitter circuitry to the transmitter antenna 316 for transmission as a mm-wave.

In the case that a separate transmitter 314a and receiver 314b are used, the receiver 314b may be equipped with a receiver antenna 318. Here, the torque measurement system 300A may be configured to monitor mm-waves that pass through the two metamaterial tracks 310 and 312 (e.g., the mutually coupled structure) instead of monitoring reflected mm-waves, as is the case with the transceiver 314. As a result, the receiver antenna 318 may be configured to receive partially transmitted mm-waves as a result of the transmitted mm-wave interacting with (e.g., being partially absorbed by and transmitted through) the metamaterial tracks 310 and 312 (e.g., the mutually coupled structure).

In some implementations, the transceiver 314, transmitter 314a, and/or receiver 314b may include additional transmitter antennas for transmitting additional transmit waves, and/or receiver antennas for receiving additional receive waves. Regardless of the configuration, it will be understood that at least one transmitter and at least one receiver is implemented for transmitting and receiving mm-wave beams. The transmitters and receivers may be electrically coupled to a system controller and/or a digital signal processor (DSP).

As noted above, the two metamaterial tracks 310 and 312 are close enough that the tracks have a mutual coupling (e.g., an electric field coupling, a magnetic field coupling, or an electromagnetic field coupling) with each other, thereby forming a resonant structure that results in a torque-dependent shift of the transmission or the reflection of a mm-wave that is caused by the resonant structure. The torque-dependent mutual coupling between the two metamaterial tracks 310 and 312 may be capacitive, inductive, or a combination of capacitive and inductive. In the latter case, one type of coupling may be dominant. For example, capacitive coupling or inductive coupling between the two metamaterial tracks 310 and 312 may be dominant.

As an example, the two metamaterial tracks 310 and 312 may be made up of elementary structures 115. The elementary structures 115 of the two metamaterial tracks 310 and 312 may be coupled together to form a split ring resonator 118 as an elementary structure having two poles, which is a resonator whose poles are modified by the rotational shift between the two metamaterial tracks 310 and 312 caused by the applied torque. Thus, the mutual coupling characteristic between the two metamaterial tracks 310 and 312 changes based on the rotational displacement that the two metamaterial tracks 310 and 312 undergo as a result of the applied torque. As a result, one or more properties (e.g., amplitude and/or phase) of the wave emitted from the resonant multitrack structure formed by the two metamaterial tracks 310 and 312 change based on the rotational displacement, which changes based on the applied torque.

In another example, the two metamaterial tracks 310 and 312 may be made up of elementary structures 100. The elementary structures of the two metamaterial tracks 310 and 312 may be coupled together to form a stacked split ring resonator structure 117 having four poles (e.g., two poles for each elementary structure 100), which is a resonator whose poles are modified by the rotational shift between the two metamaterial tracks 310 and 312 caused by the applied torque. Thus, the mutual coupling characteristic between the two metamaterial tracks 310 and 312 may change based on the rotational displacement that the two metamaterial tracks 310 and 312 undergo as a result of the applied torque. As a result, one or more properties (e.g., amplitude and/or phase) of the wave emitted from the resonant multitrack structure formed by the two metamaterial tracks 310 and 312 changes based on the rotational displacement, which changes based on the applied torque.

It will be appreciated that other combinations of elementary structures may be used, forming different types of mutually coupled structures that have one or more characteristics that change based on the rotational displacement caused by the applied torque. In some implementations, the first metamaterial track 310 may be made up of one type of elementary structure, and the second metamaterial track 312 may be made up of a different type of elementary structure.

It should be noted that the mm-wave, being an electromagnetic wave, has an electrical field component that stimulates the capacitance of a metamaterial track or the resonant multitrack structure, and has a magnetic field component that stimulates the inductance of a metamaterial track or the resonant multitrack structure. Each elementary structure reflects a part of the mm-wave directly, transmits a part of the mm-wave directly, and receives a part of the energy and stores it in its resonance oscillation. The oscillation caused by the transmission radiates a part of the energy in either direction. Thus, each metamaterial track absorbs part of the energy and stores part of the energy of a mm-wave. Additionally, each metamaterial track eventually emits the energy that has been absorbed and stored.

The resonant multitrack structure, also referred to as a mutually coupled (multitrack) structure, may also be viewed as a single structure that emits a mm-wave, either as a reflection and/or a transmission, in response to the transmitted mm-wave from the transceiver 314 impinging thereon. This emitted wave may have a torque-dependent property that may be evaluated by the receiver circuit to determine the applied torque. For example, a phase shift and/or an amplitude shift of the received signal with respect to the transmitted mm-wave may be determined and evaluated to determine the applied torque.

In particular, when the rotational shaft 308 rotates, there is a torque-dependent shift in angular position (e.g., an angular shift or rotational shift) between the two metamaterial tracks 310 and 312 due to the torque applied to the rotational shaft 308. For example, the first rotatable carrier structure 302 and the second rotatable carrier structure 304 may rotate by different amounts due to the applied torque. As a result, the absolute angular position or discrete angular value corresponding to the first metamaterial track 310 may be different from the absolute angular position or discrete angular value corresponding to the second metamaterial track 312, resulting in an angular difference or angular shift that is proportional to the applied torque. The coupling effect between the two metamaterial tracks 310 and 312 is torque-dependent and changes based on their angular shift resultant from the applied torque. This change in coupling in turn impacts at least one coupling-dependent property of an electromagnetic wave interacting with the mutually coupled structure, which can be measured to determine the applied torque.

A processor of the receiver circuit may be configured to receive at least one electromagnetic wave from the mutually coupled structure and determine the applied torque based on one or more evaluated properties of the at least one received electromagnetic wave. The processor may determine the applied torque based on the evaluated property or properties using, for example, a look-up table or an algorithm.

For example, the electromagnetic wave emitted by the mutually coupled structure formed by the two metamaterial tracks 310 and 312 may have at least one property or a combination of properties unique to the angular shift between the two metamaterial tracks 310 and 312, and, thus, unique to the applied torque. This measurement technique may be referred to as a direct torque measurement.

Alternatively, the processor may receive an electromagnetic wave from each of the two metamaterial tracks 310 and 312, determine a torque-dependent absolute angular position corresponding to each metamaterial track, determine the angular difference therefrom, and then determine the applied torque based on the determined angular difference using, for example, a look-up table or an algorithm. In this case, the two metamaterial tracks 310 and 312 may have array elementary structures that vary in the rotation direction so that the angular position of each track can be determined. This measurement technique is referred to as an indirect torque measurement.

The transceiver 314 may use a direct torque measurement for measuring the applied torque. For instance, the transceiver 314 may transmit a continuous mm-wave as a carrier signal that has a constant frequency at the mutually coupled structure formed by the two metamaterial tracks 310 and 312. The mutually coupled structure may receive the carrier signal and may partially reflect the carrier signal back at the transceiver 314. The mutual coupling between the two metamaterial tracks 310 and 312 depends on the applied torque, which affects a torque-dependent property of the reflected signal. The transceiver 314 may include a demodulator that is configured to demodulate the received signal and a processor (e.g., a DSP) that is configured to evaluate a property of the received signal using at least one of phase analysis, amplitude analysis, or spectral analysis, and determine the applied torque based on the evaluated property. In particular, the processor may be configured to determine a phase and/or an amplitude of each received signal, and compare the determined phase and/or amplitude to the phase and/or amplitude of the carrier signal, respectively, to derive the applied torque. A certain change in phase or amplitude relative to the carrier signal (e.g., a phase shift or an amplitude shift) may correspond to the applied torque.

In summary, the torque measurement system 300A may include two target objects (e.g., the two rotatable carrier structures 302 and 304) each with a metamaterial pattern coupled to their neighboring surfaces. Each target object may be fixed to the rotational shaft 308 with a certain lateral distance therebetween. If a torque is applied to the rotational shaft 308, the rotational shaft 308 twists depending on a thickness and a Young's modulus of the rotational shaft 308. The lateral distance between the two target objects is close enough to ensure that the two metamaterial tracks 310 and 312 are mutually coupled. Depending on the rotational shift of the two metamaterial patterns of the two metamaterial tracks 310 and 312, the coupling effect between the two metamaterial tracks 310 and 312 changes. This coupling effect is unique to the amount of applied torque. As a result, the change in the coupling effect causes a property of one or more waves emitted from the metamaterial tracks 310 and 312 to be altered, which can be measured and analyzed for determining the applied torque.

As indicated above, FIG. 3A is provided as an example. Other examples may differ from what is described with regard to FIG. 3A. The number and arrangement of devices and components shown in FIG. 3A are provided as an example. In practice, there may be additional devices or components, fewer devices or components, different devices or components, or differently arranged devices or components than those shown in FIG. 3A. Furthermore, two or more devices or components shown in FIG. 3A may be implemented within a single device or component, or a single device or component shown in FIG. 3A may be implemented as multiple, distributed devices or components. Additionally, or alternatively, a set of devices or components (e.g., one or more devices or components) shown in FIG. 3A may perform one or more functions described as being performed by another set of devices or components shown in FIG. 3A.

FIG. 3B is a schematic view of a torque measurement system 300B according to one or more embodiments. The torque measurement system 300B is similar to the torque measurement system 300A depicted in FIG. 3A, with the exception that the torque measurement system 300B includes additional metamaterial tracks on each rotatable carrier structure 302 and 304. For example, the torque measurement system 300B may include a third metamaterial track 320 (e.g., a mm-wave metamaterial track) coupled to the first rotatable carrier structure 302 as a third metamaterial layer. Additionally, the torque measurement system 300B may include a fourth metamaterial track 322 (e.g., a mm-wave metamaterial track) coupled to the second rotatable carrier structure 304 as a fourth metamaterial layer. The fourth metamaterial track 322 is spaced apart from the third metamaterial track 320 in the axial direction of the rotational shaft 308. In some implementations, the third metamaterial track 320 may be referred to as a third metamaterial array, and the fourth metamaterial track 322 may be referred to as a fourth metamaterial array.

As a result, the first metamaterial track 310 and the third metamaterial track 320 are attached to the first rotatable carrier structure 302, and the second metamaterial track 312 and the fourth metamaterial track 322 are attached to the second rotatable carrier structure 304. The first metamaterial track 310 and the third metamaterial track 320 attached to the first rotatable carrier structure 302 may be concentric loops located at different radial distances from the rotational axis 306. Similarly, the second metamaterial track 312 and the fourth metamaterial track 322 attached to the second rotatable carrier structure 304 may be concentric loops located at different distances from the rotational axis 306.

Furthermore, metamaterial tracks 310 and 312 are aligned (i.e., are located at a first radial distance from the rotational axis 306) and are in close proximity such that they are mutually coupled. Similarly, metamaterial tracks 320 and 322 are aligned (i.e., are located at a second radial distance from the rotational axis 306) and are in close proximity such that they are mutually coupled. In this example, the second radial distance from the rotational axis 306 is less than the first radial distance from the rotational axis 306. Thus, two mutually coupled structures are formed, where the first one is formed by metamaterial tracks 310 and 312, and the second one is formed by metamaterial tracks 320 and 322.

Thus, the first metamaterial track 310 and the second metamaterial track 312 form a first pair of metamaterial arrays that are mutually coupled to each other by a first torque-dependent coupling, thereby forming a first mutually coupled structure. The first torque-dependent coupling may affect a first mm-wave property (e.g., amplitude and/or phase) of the first mutually coupled structure such that the first mm-wave property changes based on the torque applied to the rotational shaft 308. The first mutually coupled structure formed by the first pair of metamaterial arrays may have a first resonance frequency that corresponds to the first torque-dependent coupling. A change in the first torque-dependent coupling may cause the first resonance frequency to change by a first amount corresponding to an applied torque. In other words, in response to a torque applied to the rotational shaft 308, the first metamaterial track 310 and the second metamaterial track 312 of the first pair of metamaterial arrays are configured to undergo a first rotational shift relative to each other. For example, in response to the torque applied to the rotational shaft 308, the first metamaterial track 310 and the second metamaterial track 312 may rotate about the rotational axis 306 by differing amounts of rotation, causing the first rotational shift and resulting in a first torque-dependent change to the first torque-dependent coupling. The first rotational shift may occur in a circumferential direction.

Additionally, the third metamaterial track 320 and the fourth metamaterial track 322 form a second pair of metamaterial arrays that are mutually coupled to each other by a second torque-dependent coupling, thereby forming a second mutually coupled structure. The second torque-dependent coupling may affect a second mm-wave property (e.g., amplitude and/or phase) of the second mutually coupled structure such that the second mm-wave property changes based on the torque applied to the rotational shaft 308. The second mutually coupled structure formed by the second pair of metamaterial arrays may have a second resonance frequency that corresponds to the second torque-dependent coupling. A change in the second torque-dependent coupling may cause the second resonance frequency to change by a second amount corresponding to the same applied torque. In other words, in response to a torque applied to the rotational shaft 308, the third metamaterial track 320 and the fourth metamaterial track 322 of the second pair of metamaterial arrays are configured to undergo a second rotational shift relative to each other. For example, in response to the torque applied to the rotational shaft 308, the third metamaterial track 320 and the fourth metamaterial track 322 may rotate about the rotational axis 306 by differing amounts of rotation, causing the second rotational shift and resulting in a second torque-dependent change to the second torque-dependent coupling. The second rotational shift may occur in the circumferential direction.

Moreover, the metamaterial arrays of first pair of metamaterial arrays and the metamaterial arrays of the second pair of metamaterial arrays may be configured such that a change in the first torque-dependent coupling caused by the applied torque is different than a change in the second torque-dependent coupling caused by the same applied torque. For example, a rate of change of the first torque-dependent coupling is different than a rate of change of the second torque-dependent coupling. The rate of change of the first torque-dependent coupling may be higher than the rate of change of the second torque-dependent coupling in at least some ranges of torque applied. In some examples, the absolute value of the maximum rate of change of the first torque-dependent coupling may be higher than the absolute value of the maximum rate of change of the second torque-dependent coupling. Thus, the first torque-dependent coupling and the second torque-dependent coupling change by differing amounts based on the same applied torque.

In some implementations, elementary structures of the first metamaterial track 310 and the third metamaterial track 320 may be interleaved or intermixed on the first rotatable carrier structure 302. Additionally, elementary structures of the second metamaterial track 312 and the fourth metamaterial track 322 may be interleaved or intermixed on the second rotatable carrier structure 304. For example, the elementary structures of the first metamaterial track 310 and the third metamaterial track 320 may be different in size, shape, and/or orientation relative to a size, shape, and/or orientation of the elementary structures of the second metamaterial track 312 and the fourth metamaterial track 322. For example, first elementary structures of the first metamaterial track 310 and second elementary structures of the second metamaterial track 312 may have a first structure size, and third elementary structures of the third metamaterial track 320 and fourth elementary structures of the fourth metamaterial track 320 may have a second structure size that is different from the first structure size. As a result, a property of the first torque-dependent coupling may be different from a property of the second torque-dependent coupling. For example, the first pair of metamaterial arrays and the second pair of metamaterial arrays may have different resonance frequencies. In other words, the resonance frequencies of the two pairs may be different when no torque is applied or in response to a same torque being applied.

In some implementations, the first, second, third, and fourth elementary structures may be identical and/or have a same structure size. However, in this case, the metamaterial arrays of first pair of metamaterial arrays and the metamaterial arrays of the second pair of metamaterial arrays are configured to be spatially separated and distinguishable (e.g., by separate radial distances), and not interleaved or intermixed, in order to enable measurements of the two different pairs of metamaterial arrays. For example, the first pair and the second pair of metamaterial arrays may have a same resonance frequency when no torque is applied to the rotational shaft 308. Thus, spatial separation between the two pairs in the radial direction may be needed in order to be able to measure respective electromagnetic waves originating from the two pairs of metamaterial arrays.

In addition, the torque measurement system 300B includes two antennas A1 and A2 both configured to transmit and receive mm-wave signals. Here, antenna A1 is aligned with the first pair of metamaterial arrays (e.g., the first metamaterial track 310 and the second metamaterial track 312), and is configured to transmit a mm-wave beam at those mutually coupled tracks and receive reflected signals therefrom. Similarly, antenna A2 is aligned with the second pair of metamaterial arrays (e.g., the third metamaterial track 320 and the fourth metamaterial track 322), and is configured to transmit a mm-wave beam at those mutually coupled tracks and receive reflected signals therefrom. Alternatively, a single transmit antenna may be used to transmit mm-wave beams at both the first pair of metamaterial arrays and the second pair of metamaterial arrays. One or more receiver antennas may be used for receiving electromagnetic receive waves (e.g., reflected signals or transmitted signals). For example, when a single receiver antenna is used, frequency multiplexing may be used at the receiver to separate electromagnetic receive waves originating from the first pair of metamaterial arrays from electromagnetic receive waves originating from the second pair of metamaterial arrays. Alternatively, a first receiver antenna may be configured to receive electromagnetic receive waves originating from the first pair of metamaterial arrays, and a second receiver antenna may be configured to receive electromagnetic receive waves originating from the second pair of metamaterial arrays. Alternatively, or additionally, a configuration of a transmitter 314a and receiver 314b, as described in connection with FIG. 3A, may be used for transmitting and receiving electromagnetic waves, such as mm-waves.

As a result, different regions of metamaterial tracks can be arranged on the carrier structures and provide different measurements. Preferably, the different regions at which the metamaterial tracks on a same carrier structure are attached are spaced in a way that the coupling between an inner ring and an outer ring is negligible compared to the coupling between the rings on the different carrier structures. For example, the first metamaterial track 310 and the second metamaterial track 312 are strongly coupled by a field effect, whereas tracks of the first metamaterial track 310 and the third metamaterial track 320 are weakly coupled or not coupled by a field effect. For this reason, the first metamaterial track 310 and the second metamaterial track 312 may form a first coupled pair of tracks, and the third metamaterial track 320 and the fourth metamaterial track 322 may form a second coupled pair of tracks.

An antenna A1 or A2 may be associated with each mutually coupled structure. Preferably the antennas A1 and A2 should have a directional characteristic that focuses their transmission and reception on the associated rings of the metamaterial structures. Thus, antenna A1 may have a directional characteristic associated with the first metamaterial track 310 and the second metamaterial track 312 (i.e., a first mutually coupled structure), and antenna A2 may have a directional characteristic associated with the third metamaterial track 320 and the fourth metamaterial track 322 (i.e., a second mutually coupled structure).

The displacement of the elementary structures of the outer tracks (e.g., the first metamaterial track 310 and the second metamaterial track 312) will be different than the displacement of the elementary structures of the inner tracks (e.g., the third metamaterial track 320 and the fourth metamaterial track 322) due to the different radii (d1=r1*da; d2=r2*da) and/or different structure sizes and spacing. Consequently, the change of the mm-wave property is less on the inner track than on the outer track. In other words, a same angle shift of the rotational shaft 308 causes a different change in the coupling of the two pairs of coupled tracks, resulting in two different signal modulations (e.g., amplitude and/or phase) in the receive waves generated by the different coupled pairs of tracks. Also, the absolute value of the maximum rate of change in the coupling is different for the two pairs of coupled tracks.

In some implementations, the first mutually coupled structure (e.g., the first pair metamaterial arrays) has a first resonance frequency and the second mutually coupled structure (e.g., the second pair metamaterial arrays) has a second resonance frequency. A change in the first torque-dependent coupling may cause the first resonance frequency to change by a first amount, and a change in the second torque-dependent coupling may cause the second resonance frequency to change by a second amount that is different from the first amount. Also, the absolute value of the maximum rate of change in the resonance frequency is thereby different for the two pairs of coupled tracks.

In some implementations, the first torque-dependent coupling has a first torque sensitivity, and the second torque-dependent coupling has a second torque sensitivity that is lower than the first torque sensitivity. For example, since the first mutually coupled structure may be located at a larger radial distance than the second mutually coupled structure, the first metamaterial track 310 and the second metamaterial track 312 may undergo a larger rotational shift relative to each other than a rotational shift experienced by the third metamaterial track 320 and the fourth metamaterial track 322. In other words, a same torque may result in a larger shift in the first torque-dependent coupling than in the second torque-dependent coupling. Thus, the first mutually coupled structure may be more sensitive to torque and provide a higher measurement resolution than the second mutually coupled structure.

In addition, the first torque-dependent coupling may have a first unambiguous measurement range of applied torque, and the second torque-dependent coupling may have a second unambiguous measurement range of applied torque that is different from the first unambiguous measurement range of applied torque. The unambiguous measurement range is related to the periodicity of the measurement signal and defined by the span of the region between two extrema (max and min) of the measurement signal. For example, since the first mutually coupled structure may have a higher torque sensitivity, the first mutually coupled structure may have a smaller unambiguous measurement range than the second mutually coupled structure. For example, the first torque-dependent coupling may have an unambiguous measurement range of 0-N and the second torque-dependent coupling may have an unambiguous measurement range of 0-M, where N is less than M.

The torque measurement system 300B may perform torque measurements in a number of ways depending on antenna configuration. In some implementations, the torque measurement system 300B may include at least one transmitter (e.g., transceiver 314 or transmitter 314a) configured to transmit a first electromagnetic transmit wave toward the first mutually coupled structure, and transmit a second electromagnetic transmit wave toward the second mutually coupled structure. The first mutually coupled structure may convert the first electromagnetic transmit wave into a first electromagnetic receive wave based on the first rotational shift resultant from torque applied to the rotational shaft 308. The second mutually coupled structure may convert the second electromagnetic transmit wave into a second electromagnetic receive wave based on the second rotational shift resultant from torque applied to the rotational shaft 308. Thus, two separate transmitter antennas may be used to transmit the first electromagnetic transmit wave and the second electromagnetic transmit wave.

Additionally, the torque measurement system 300B may include at least one receiver (e.g., transceiver 314 or receiver 314b) configured to receive the first electromagnetic receive wave and the second electromagnetic receive wave. Two separate receiver antennas or a single receiver antenna with frequency multiplexing may be used to receive and measure the first electromagnetic receive wave and the second electromagnetic receive wave. The receiver circuitry may monitor a first measurement of the first electromagnetic receive wave, and compare the first measurement to a torque threshold. The receiver circuitry may, based on the first measurement not satisfying the torque threshold, determine the torque applied to the rotational shaft based on the first measurement. For example, when the first measurement is less than the torque threshold, the receiver circuitry may select electromagnetic waves received from the first mutually coupled structure (e.g., the first metamaterial track 310 and the second metamaterial track 312) to measure the torque. In contrast, the receiver circuitry may, based on the first measurement satisfying the torque threshold, determine the torque applied to the rotational shaft based on a second measurement of the second electromagnetic receive wave. For example, when the first measurement is equal to or greater than the torque threshold, the receiver circuitry may select electromagnetic waves received from the second mutually coupled structure (e.g., the third metamaterial track 320 and the fourth metamaterial track 322) to measure the torque. In some implementations, the torque threshold may be set to an upper limit of the unambiguous measurement range of 0-N.

The first mutually coupled structure may be configured to modify the first electromagnetic transmit wave based on the first torque-dependent coupling, thereby producing the first electromagnetic receive wave, the first electromagnetic receive wave having a first parameter value based on the torque applied to the rotational shaft. The receiver circuitry may measure the first parameter value as the first measurement. The second mutually coupled structure may be configured to modify the second electromagnetic transmit wave based on the second torque-dependent coupling, thereby producing the second electromagnetic receive wave, the second electromagnetic receive wave having a second parameter value based on the torque applied to the rotational shaft. The receiver circuitry may measure the second parameter value as the second measurement.

Alternatively, the receiver circuitry may receive the first electromagnetic receive wave and the second electromagnetic receive wave, and determine the torque applied to the rotational shaft based on a first measurement of the first electromagnetic receive wave and based on a second measurement of the second electromagnetic receive wave. For example, the receiver circuitry may use the second measurement from the second mutually coupled structure, which may have lower resolution, to estimate an angular shift caused by the torque. This may be regarded as a coarse measurement. The receiver circuitry may use the estimated angular shift to determine a range of angular shift values corresponding to a shift of the first mutually coupled structure. In other words, the second measurement is used to identify a angular segment which corresponds to the first measurement. The receiver circuitry may then use the first measurement from the first mutually coupled structure to determine an absolute angular shift with fine resolution caused by the torque based on cross-referencing the first measurement with the range of angular shift values. In some implementations, the receiver circuitry may use a first look-up table to determine the range of angular shift values from the second measurement. The range of angular shift values may correspond to a range of absolute angular shift values in a second look-up table. The receiver circuitry may use the second look-up table to determine the absolute angular shift among the range of absolute angular shift values based on the first measurement. The absolute angular shift may correspond to a specific torque value corresponding to the applied torque.

Using another antenna configuration, the torque measurement system 300B may include at least one transmitter (e.g., transceiver 314 or transmitter 314a) configured to transmit an electromagnetic transmit wave toward the first mutually coupled structure and the second mutually coupled structure. Thus, one transmitter antenna may be used to transmit the one electromagnetic transmit wave to both the first mutually coupled structure and the second mutually coupled structure. This may be possible, for example, when the metamaterial arrays coupled to the same rotatable carrier structure are intermixed or interleaved. The first mutually coupled structure may convert the electromagnetic transmit wave into a first electromagnetic receive wave based on the first rotational shift, and the second mutually coupled structure may convert the electromagnetic transmit wave into a second electromagnetic receive wave based on the second rotational shift.

Additionally, the torque measurement system 300B may include at least one receiver (e.g., transceiver 314 or receiver 314b) configured to receive the first electromagnetic receive wave and the second electromagnetic receive wave. Two separate receiver antennas or a single receiver antenna with frequency multiplexing may be used to receive and measure the first electromagnetic receive wave and the second electromagnetic receive wave. The receiver circuitry may monitor a first measurement of the first electromagnetic receive wave, and compare the first measurement to the torque threshold. The receiver circuitry may, based on the first measurement not satisfying the torque threshold, determine the torque applied to the rotational shaft based on the first measurement. For example, when the first measurement is less than the torque threshold, the receiver circuitry may select electromagnetic waves received from the first mutually coupled structure (e.g., the first metamaterial track 310 and the second metamaterial track 312) to measure the torque. In contrast, the receiver circuitry may, based on the first measurement satisfying the torque threshold, determine the torque applied to the rotational shaft based on a second measurement of the second electromagnetic receive wave. For example, when the first measurement is equal to or greater than the torque threshold, the receiver circuitry may select electromagnetic waves received from the second mutually coupled structure (e.g., the third metamaterial track 320 and the fourth metamaterial track 322) to measure the torque. In some implementations, the torque threshold may be set to an upper limit of the unambiguous measurement range of 0-N.

Alternatively, the receiver circuitry may receive the first electromagnetic receive wave and the second electromagnetic receive wave, and determine the torque applied to the rotational shaft based on a first measurement of the first electromagnetic receive wave and based on a second measurement of the second electromagnetic receive wave. For example, the receiver circuitry may use the first measurement and the second measurement in combination to determine an absolute angular shift (e.g., by a combination of look-up tables).

In some implementations, principles of measuring torque by the torque measurement system 300B may be extended to linear measurement systems as well as rotational measurement systems. For example, a measurement system with two mutually coupled structures may be configured to measure a force, a strain, or an angular displacement, and/or a linear displacement. For example, a first carrier structure and a second carrier structure may be configured to allow a relative shift (e.g., linear or rotational) between the first carrier structure and the second carrier structure such that the first metamaterial track 310 and the second metamaterial track 312 undergo a first positional shift relative to each other, and the third metamaterial track 320 and the fourth metamaterial track 322 undergo a second positional shift relative to each other. Moreover, a change in the first shift-dependent coupling caused by the relative shift between the first carrier structure and the second carrier structure is different than a change in the second shift-dependent coupling caused by the relative shift between the first carrier structure and the second carrier structure. An applied relative shift may cause the relative shift (e.g., linear or rotational) between the first carrier structure and the second carrier structure.

The first mutually coupled structure may have a first resonance frequency and the second mutually coupled structure may have a second resonance frequency. The change in the first shift-dependent coupling may cause the first resonance frequency to change by a first amount, and the change in the second shift-dependent coupling may cause the second resonance frequency to change by a second amount that is different from the first amount. The first shift-dependent coupling may have a first sensitivity to the relative shift, and the second shift-dependent coupling may have a second sensitivity to the relative shift that is lower than the first sensitivity. The first shift-dependent coupling may have a first unambiguous measurement range, and the second shift-dependent coupling may have a second unambiguous measurement range that is different from the first unambiguous measurement range.

In some implementations, the first metamaterial track 310 and the second metamaterial track 312 are mutually coupled to each other by a first force-dependent coupling, thereby forming the first mutually coupled structure, and the third metamaterial track 320 and the fourth metamaterial track 322 are mutually coupled to each other by a second force-dependent coupling, thereby forming the second mutually coupled structure. In response to a force applied to at least one of the first carrier structure or the second carrier structure, the first metamaterial array and the second metamaterial array are configured to undergo a first positional shift relative to each other, and the third metamaterial array and the fourth metamaterial array are configured to undergo a second positional shift relative to each other. A change in the first force-dependent coupling caused by the force is different than a change in the second force-dependent coupling caused by the same force. Additionally, the first force-dependent coupling may have a first force sensitivity, and the second force-dependent coupling may have a second force sensitivity that is lower than the first force sensitivity.

As indicated above, FIG. 3B is provided as an example. Other examples may differ from what is described with regard to FIG. 3B. The number and arrangement of devices and components shown in FIG. 3B are provided as an example. In practice, there may be additional devices or components, fewer devices or components, different devices or components, or differently arranged devices or components than those shown in FIG. 3B. Furthermore, two or more devices or components shown in FIG. 3B may be implemented within a single device or component, or a single device or component shown in FIG. 3B may be implemented as multiple, distributed devices or components. Additionally, or alternatively, a set of devices or components (e.g., one or more devices or components) shown in FIG. 3B may perform one or more functions described as being performed by another set of devices or components shown in FIG. 3B.

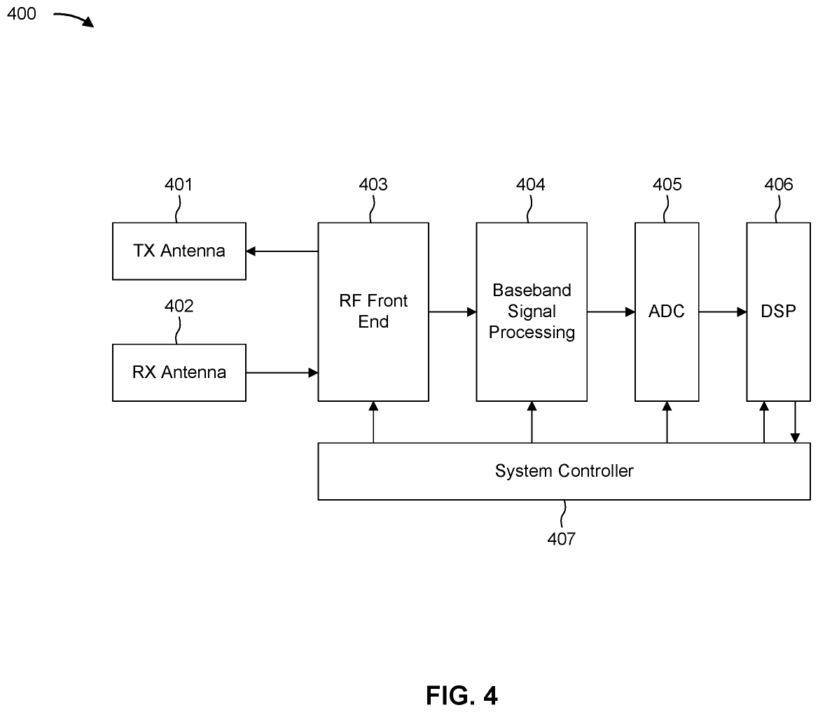

FIG. 4 illustrates an example transceiver circuit of a transceiver 400 according to one or more implementations. The transceiver 400 is representative of any transmitter/receiver combination. The transceiver 400 includes relevant transmitter circuitry and receiver circuitry corresponding to the implementations described herein. It will also be appreciated that the transmission circuitry and the receiver circuitry may be distributed between a transmitter and a receiver that are provided separate from each other.

Frequency modulation may be used on a transmitter side to characterize a transfer function of a transmission channel including the metamaterial over frequency. However, a continuous carrier wave with a constant frequency may also be used.

On the measurement side (e.g., a receiver side), measured properties may be magnitude (amplitude) and phase or in-phase and quadrature components (e.g., I and Q), which may be the most sophisticated and flexible solution. However, with respect to cost, a system with a constant frequency carrier may be preferable. In this case, a frequency may be chosen to be in a defined region with respect to poles and zeros where a phase or amplitude transfer function has a monotonous behavior with respect to the modified property of the metamaterial. Then, a local measurement of phase shift or amplitude attenuation may be used.

Accordingly, a transmission (TX) antenna configuration 401 (e.g., at least one transmission antenna) and a reception (RX) antenna configuration 402 (e.g., at least one receiver antenna) are connected to an RF front end 403 integrated into a chip. The RF front end may contain circuit components that are used for RF signal processing. These circuit components may comprise, for example, a local oscillator (LO), RF power amplifiers, low noise amplifiers (LNA), directional couplers (e.g., rat-race couplers, circulators), and mixers for down-mixing (or down-converting) the RF signals into baseband or an intermediate frequency band (IF band). The RF front end 403 may—possibly together with further circuit components—be integrated into a chip, which may be referred to as a monolithic microwave integrated circuit (MMIC).

The example 400 shows a bistatic (or pseudo-monostatic) radar system with separate RX and TX antennas. In the case of a monostatic radar system, a single antenna may be used both to emit and to receive the electromagnetic (radar) signals. In this case, a directional coupler (e.g., a circulator) may be used to separate the RF signals to be emitted from the received RF signals (radar echo signals). Radar systems, in practice, usually have a plurality of transmission and reception channels (TX/RX channels) with a plurality of TX and RX antennas, which makes it possible, inter alia, to measure a direction of arrival (DoA) from which the radar echoes are received. In such multiple-input multiple-output (MIMO) systems, the individual TX channels and RX channels in each case usually have an identical or similar structure.

In the case of a frequency modulated continuous wave (FMCW) radar system, the RF signals emitted by the TX antenna configuration 401 may be, for example, in the range of approximately 10 GHz to 1 THz. However, the frequency bands that are applied here depend on the elementary structures to be used for the generation of the metamaterial target. As mentioned, the RF signal received by the RX antenna configuration 402 comprises the radar echoes (chirp echo signals)—that is to say, those signal components that are backscattered at one or at a plurality of radar targets. The received RF signal is down-mixed, for example, into baseband (or an IF band) and processed further in baseband by way of analog signal processing (see analog baseband signal processing circuitry 404) in order to determine a characteristic of the received RF signal, such as an amplitude, a frequency, or a phase shift.

The analog baseband signal processing circuitry 404 may comprise one or more filters and one or more amplifiers for filtering and amplifying the baseband signal. The baseband signal is digitized by an analog-to-digital converter (ADC) 405 and processed further in the digital domain. The digital signal processing chain may be implemented at least partly in the form of software that is able to be executed on a processor (for example a microcontroller, a DSP 406, or another computer unit).

The overall system is generally controlled by way of a system controller 407 that may likewise be implemented at least partly in the form of software that is able to be executed on a processor, such as, for example, a microcontroller. The RF front end 403 and the analog baseband signal processing circuitry 404 (optionally also the analog-to-digital converter 405) may be integrated together in a single MMIC (that is to say, an RF semiconductor chip). As an alternative, the individual components may also be distributed over a plurality of integrated circuits.

The DSP 406 may be configured to analyze measured values (e.g., parameter values) of one or more signals received from the first mutually coupled structure (e.g., the first metamaterial track 310 and the second metamaterial track 312) and/or the second mutually coupled structure (e.g., the third metamaterial track 320 and the fourth metamaterial track 322).

The DSP 406 may be configured to perform the aforementioned phase analysis, amplitude analysis, and/or spectral analysis to determine an applied torque or an applied relative shift based on, for example, the determined amplitude modulation and/or phase modulation of the received signals. The phase modulation of a received signal may be a phase shift of the received signal with respect to a phase of the transmitted mm-wave. Similarly, the amplitude modulation of a received signal may be an amplitude shift of the received signal with respect to an amplitude of the transmitted mm-wave. For example, the DSP 406 may be configured to determine a phase shift and/or an amplitude shift of a received signal and translate the shift into an angular shift between two metamaterial tracks 310 and 312 resultant from the applied torque to calculate the applied torque or directly translate the phase shift and/or an amplitude shift to the applied torque. For example, the DSP 406 may refer to a look-up table provided in memory that stores torque values corresponding to a specific amplitude modulation and/or phase modulation. Similarly, the DSP 406 may be configured to determine a phase shift and/or an amplitude shift of a received signal and translate the shift into an angular shift between two metamaterial tracks 320 and 322 resultant from the applied torque to calculate the applied torque or directly translate the phase shift and/or an amplitude shift to the applied torque. The DSP 406 may use thresholding to determine which mutually coupled structure to use for a torque measurement. Alternatively, the DSP 406 may use the first measurement and the second measurement in combination to calculate the applied torque. For example, two or more look-up tables may be used in combination, as described above. Thus, the DSP 406 may receive signals from two different mutually coupled structures (e.g., two pairs of metamaterial tracks) to calculate the applied torque.

As indicated above, FIG. 4 is provided as an example. Other examples may differ from what is described with regard to FIG. 4.

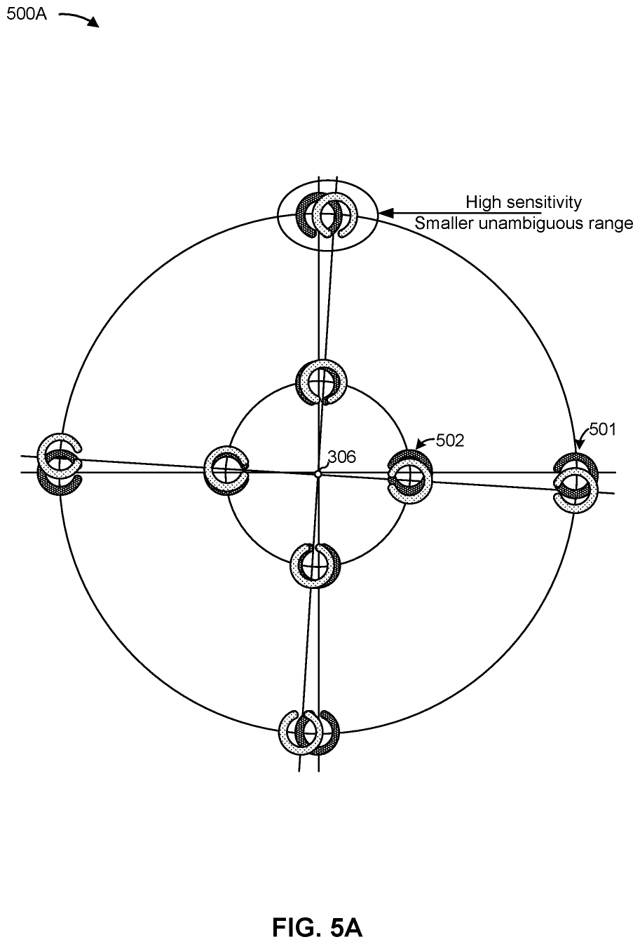

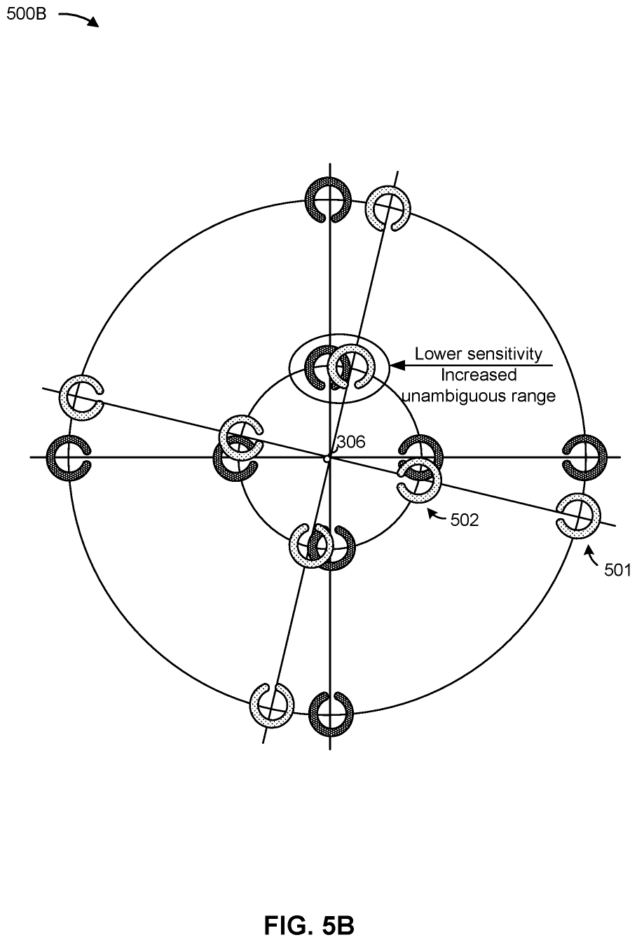

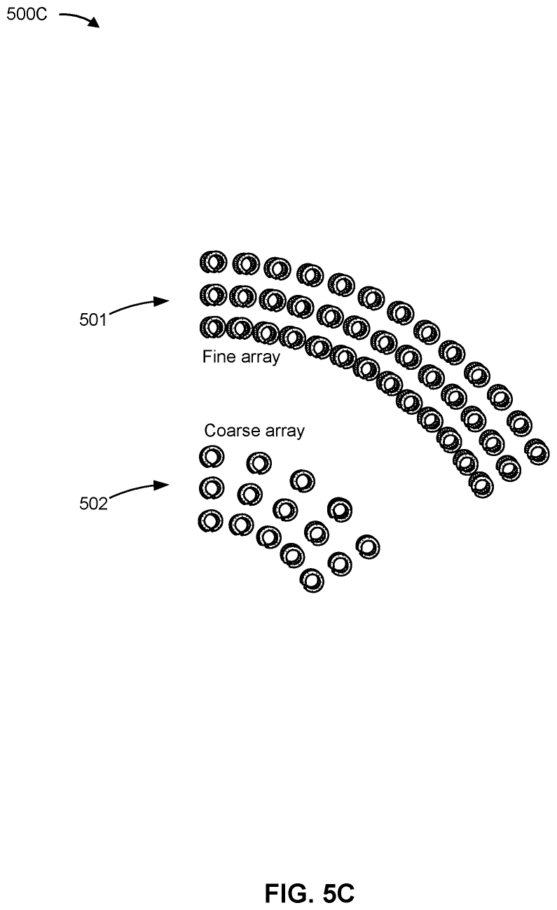

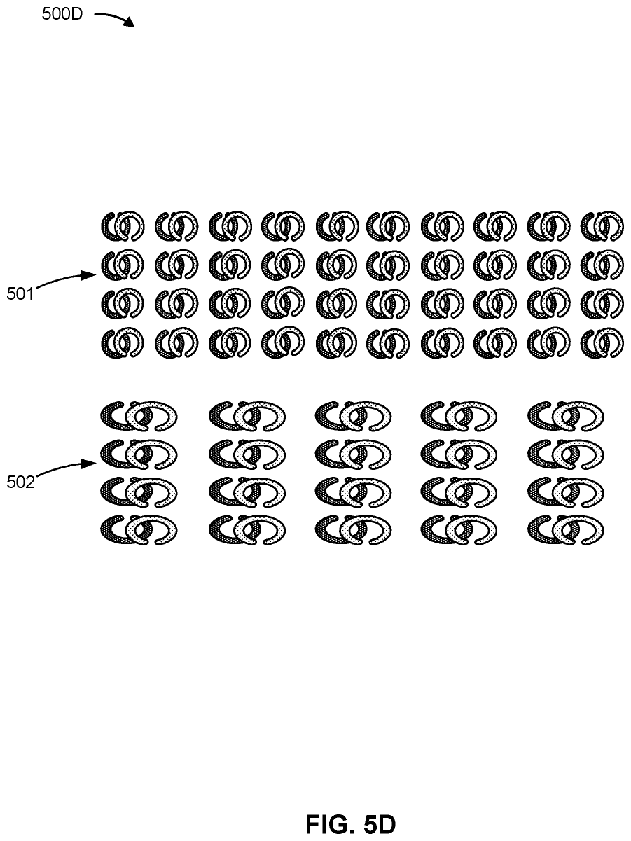

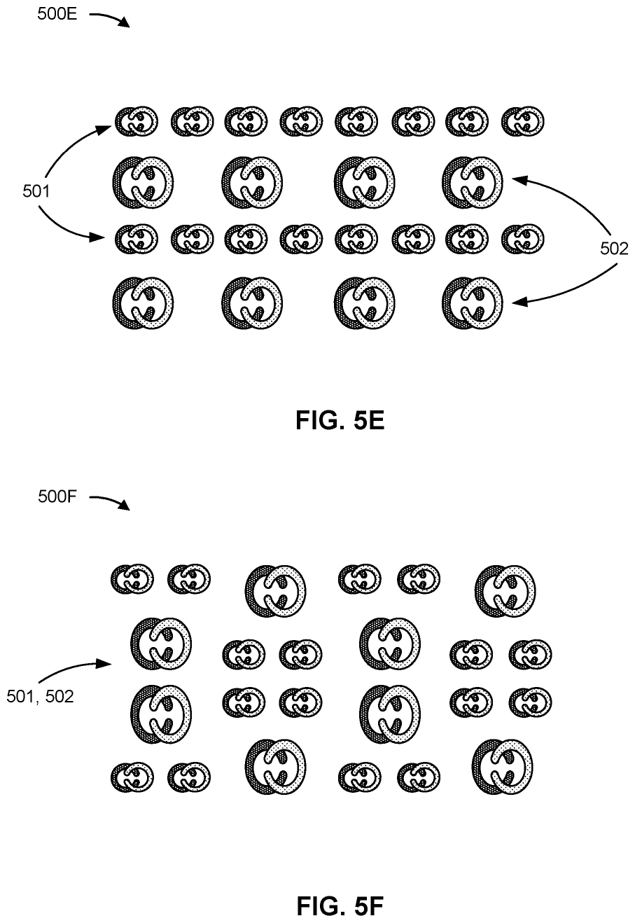

FIG. 5A illustrates a diagram 500A showing a front view of two overlapping pairs of metamaterial arrays in response to an applied torque. The two overlapping pairs of metamaterial arrays include a first overlapping pair 501 (e.g., an outer overlapping pair) and a second overlapping pair 502 (e.g., an inner overlapping pair). The first overlapping pair 501 may correspond to the first mutually coupled structure formed by the first metamaterial track 310 overlapped with the second metamaterial track 312. The second overlapping pair 502 may correspond to the second mutually coupled structure formed by the third metamaterial track 320 overlapped with the fourth metamaterial track 322. For a same applied torque, the elementary structures of the first metamaterial track 310 and the second metamaterial track 312 undergo a first rotational shift, whereas the elementary structures of the third metamaterial track 320 and the fourth metamaterial track 322 undergo a second rotational shift that is smaller than the first rotational shift due to being located at a smaller radial distance from the rotational axis 306. Accordingly, the first overlapping pair 501 has a higher sensitivity and higher local resolution than the second overlapping pair 502.

Each elementary structure of the first metamaterial track 310 may have a mutual coupling to a respective elementary structure of the second metamaterial track 312. Thus, the first unambiguous measurement range of the first mutually coupled structure may be defined by an upper torque limit where the mutual coupling between two elementary structures is maintained. Exceeding the upper torque limit may result in an elementary structure of the first metamaterial track 310 being mutually coupled with a next elementary structure of the second metamaterial track 312.

Similarly, each elementary structure of the third metamaterial track 320 may have a mutual coupling to a respective elementary structure of the fourth metamaterial track 322. Thus, the second unambiguous measurement range of the second mutually coupled structure may be defined by an upper torque limit where the mutual coupling between two elementary structures is maintained. The upper torque limit may correspond to a maximum of the measurement signal. Exceeding the upper torque limit may result in an elementary structure of the third metamaterial track 320 being mutually coupled with a next elementary structure of the fourth metamaterial track 322.

Due to the differences in rotational shift of the two overlapping pairs of metamaterial arrays, the first overlapping pair 501 may reach its upper torque limit before the second overlapping pair 502 reaches its upper torque limit.

As indicated above, FIG. 5A is provided as an example. Other examples may differ from what is described with regard to FIG. 5A.

FIG. 5B illustrates a diagram 500B showing a front view of two overlapping pairs of metamaterial arrays in response to an applied torque. The diagram 500B is similar to the diagram 500A, with an exception that a higher amount of torque is applied relative to the torque applied in FIG. 5A. As a result, the first unambiguous measurement range has been exceeded and the two elementary structures of the first overlapping pair 501 coupled in diagram 500A are no longer coupled to each other. In contrast, the higher amount of torque is still within the second unambiguous measurement range of the second overlapping pair 502. For example, the two elementary structures of the second overlapping pair 502 coupled in diagram 500A are still coupled to each other.

As indicated above, FIG. 5B is provided as an example. Other examples may differ from what is described with regard to FIG. 5B.

FIG. 5C illustrates a diagram 500C showing a front view of two overlapping pairs of metamaterial arrays. The two overlapping pairs of metamaterial arrays include the first overlapping pair 501 and the second overlapping pair 502. In this example, the first metamaterial track 310 and the second metamaterial track 312 that make up the first overlapping pair 501 are made up of fine arrays of elementary structures, whereas the third metamaterial track 320 and the fourth metamaterial track 322 that make up the second overlapping pair 502 are made up of coarse arrays of elementary structures. The elementary structures of the first metamaterial track 310, the second metamaterial track 312, the third metamaterial track 320, and the fourth metamaterial track 322 may have a same structure size. However, a spacing or gap between the elementary structures for the first overlapping pair 501 may be different (e.g., smaller) than a spacing or gap between the elementary structures for the second overlapping pair 502. As a result, the first overlapping pair 501 may have a higher resolution that the second overlapping pair 502 for torque measurements.

As indicated above, FIG. 5C is provided as an example. Other examples may differ from what is described with regard to FIG. 5C.

FIG. 5D illustrates a diagram 500D showing a front view of two overlapping pairs of metamaterial arrays. The two overlapping pairs of metamaterial arrays include the first overlapping pair 501 as another example of a fine array, and the second overlapping pair 502 as another example of a coarse array. The elementary structures of the first metamaterial track 310 and the second metamaterial track 312 may have a different (e.g. smaller) structure size than the elementary structures of the third metamaterial track 320 and the fourth metamaterial track 322. As a result, the first overlapping pair 501 may have a higher resolution that the second overlapping pair 502 for torque measurements.

As indicated above, FIG. 5D is provided as an example. Other examples may differ from what is described with regard to FIG. 5D.

FIG. 5E illustrates a diagram 500E showing a front view of two overlapping pairs of metamaterial arrays. The two overlapping pairs of metamaterial arrays include the first overlapping pair 501 as another example of a fine array, and the second overlapping pair 502 as another example of a coarse array. In this example, the first overlapping pair 501 and the second overlapping pair 502 are interleaved.

As indicated above, FIG. 5E is provided as an example. Other examples may differ from what is described with regard to FIG. 5E.

FIG. 5F illustrates a diagram 500F showing a front view of two overlapping pairs of metamaterial arrays. The two overlapping pairs of metamaterial arrays include the first overlapping pair 501 as another example of a fine array, and the second overlapping pair 502 as another example of a coarse array. In this example, the first overlapping pair 501 and the second overlapping pair 502 are intermixed.

As indicated above, FIG. 5F is provided as an example. Other examples may differ from what is described with regard to FIG. 5F.

Accordingly, referring to FIGS. 5A-5F, the elementary structures can be scaled differently for the fine and the coarse arrays. Scaled structures can have a same resonance frequency or different resonance frequencies. Elementary structures with a same resonance frequency may be arranged in separate arrays and sensed by separate mm-wave beams. Elementary structures with different resonance frequencies can also be interleaved or intermixed in one array and sensed by a same mm-wave beam using frequency multiplexing.

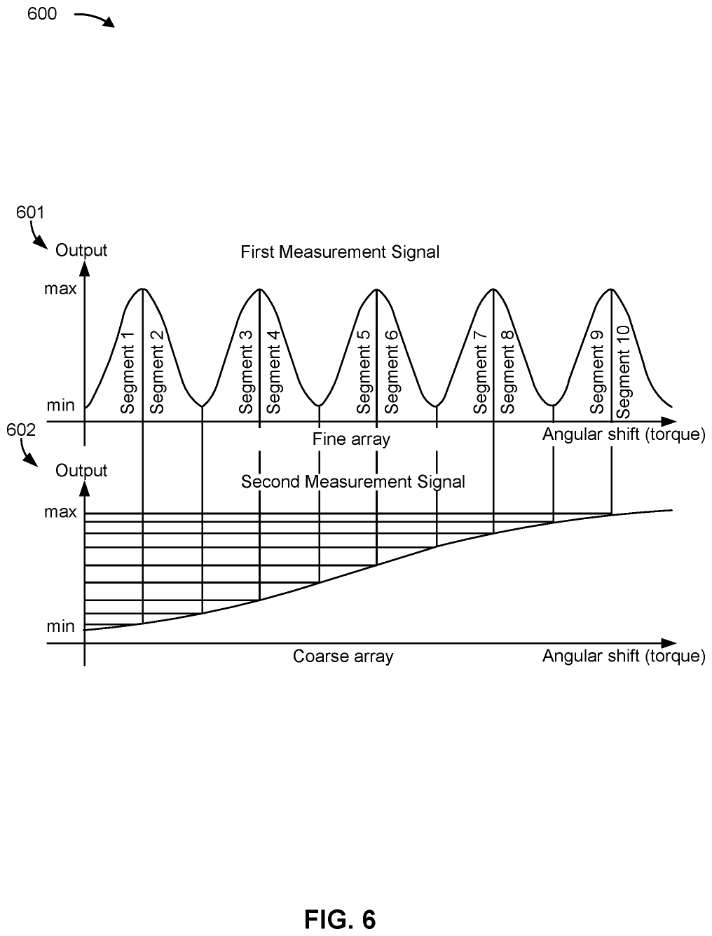

FIG. 6 illustrates an example 600 of measurement signal diagrams 601 and 602 according to one or more implementations. The measurement signal diagram 601 may represent a change in a first measurement signal corresponding to the first overlapping pair 501 over a range of applied torque. The measurement signal diagram 602 may represent a change in a second measurement signal corresponding to the second overlapping pair 502 over the range of applied torque.

The first measurement signal changes with a higher frequency than the second measurement signal. For example, an unambiguous measurement range may be defined by one signal half-period. Thus, for one signal half-period of the second measurement signal, the first measurement signal undergoes ten signal half-periods of change. In other words, the first overlapping pair 501 has a resolution that is 10 times higher than the second overlapping pair 502. However, the unambiguous measurement range of the first overlapping pair 501 is 10 times less than the second overlapping pair 502. As a result, the first overlapping pair 501 has 10 unambiguous measurement ranges, which are identified as segments. It is also to be noted that the absolute value of the maximum rate of change of the first measurement signal (which is in the middle between two extrema of the first measurement signal) is higher than the absolute value of the maximum rate of change of the second measurement signal (which is in the middle between two extrema of the second measurement signal).

The DSP 406 may determine the torque applied to the rotational shaft 308 based on a first measurement signal and based on the second measurement signal. For example, the receiver circuitry may obtain a measurement value from the second measurement signal to estimate an angular shift caused by the torque. The DSP 406 may use the estimated angular shift to determine a range of angular shift values corresponding to a shift of the first mutually coupled structure. For example, the DSP 406 may use the measurement value from the second measurement signal to determine which unambiguous measurement range or segment of the first measurement signal to use to determine the applied torque. For example, each segment of the first measurement signal corresponds to a different range of measurement values of the second measurement signal. Once the DSP 406 determines the segment of the first measurement signal to which the applied torque corresponds, the DSP 406 may use the measurement value from the first measurement signal to determine an absolute angular shift caused by the applied torque and/or an absolute value of the applied torque. For example, the DSP 406 may refer to a look-up table corresponding to the segment determined from the second measurement signal, and use the measurement value from the first measurement signal to determine the absolute angular shift or the absolute value of the applied torque from the look-up table. Each segment may have a corresponding look-up table or a corresponding section of a look-up table to be selected by the measurement value from the second measurement signal, and then evaluated by the measurement value from the first measurement signal.

As indicated above, FIG. 6 is provided as an example. Other examples may differ from what is described with regard to FIG. 6.

The following provides an overview of some Aspects of the present disclosure:

Aspect 1: A torque measurement system, comprising: a first pair of metamaterial arrays arranged at least partially around a rotational axis of a rotational shaft, wherein the first pair of metamaterial arrays are coupled to the rotational shaft and are configured to rotate about the rotational axis, wherein metamaterial arrays of the first pair of metamaterial arrays are mutually coupled to each other by a first torque-dependent coupling, thereby forming a first mutually coupled structure; and a second pair of metamaterial arrays arranged at least partially around the rotational axis of the rotational shaft, wherein the second pair of metamaterial arrays are coupled to the rotational shaft and are configured to rotate about the rotational axis, wherein metamaterial arrays of the second pair of metamaterial arrays are mutually coupled to each other by a second torque-dependent coupling, thereby forming a second mutually coupled structure, wherein, in response to a torque applied to the rotational shaft, the metamaterial arrays of the first pair of metamaterial arrays are configured to undergo a first rotational shift relative to each other, and the metamaterial arrays of the second pair of metamaterial arrays are configured to undergo a second rotational shift relative to each other, and wherein a change in the first torque-dependent coupling caused by the torque is different than a change in the second torque-dependent coupling caused by the torque.

Aspect 2: The torque measurement system of Aspect 1, wherein the first pair of metamaterial arrays includes a first metamaterial array of first elementary structures and a second metamaterial array of second elementary structures, wherein the second metamaterial array is spaced apart from the first metamaterial array in an axial direction of the rotational shaft, wherein the second pair of metamaterial arrays includes a third metamaterial array of third elementary structures and a fourth metamaterial array of fourth elementary structures, wherein the fourth metamaterial array is spaced apart from the third metamaterial array in the axial direction of the rotational shaft, and wherein, in response to the torque applied to the rotational shaft, the first metamaterial array is configured to undergo the first rotational shift relative to the second metamaterial array, and the third metamaterial array is configured to undergo the second rotational shift relative to the fourth metamaterial array.

Aspect 3: The torque measurement system of Aspect 2, wherein, in response to the torque applied to the rotational shaft, the first metamaterial array and the second metamaterial array are configured to rotate about the rotational axis by differing amounts of rotation, causing the first rotational shift and resulting in a first torque-dependent change to the first torque-dependent coupling, and wherein, in response to the torque applied to the rotational shaft, the third metamaterial array and the fourth metamaterial array are configured to rotate about the rotational axis by differing amounts of rotation, causing the second rotational shift and resulting in a second torque-dependent change to the second torque-dependent coupling.

Aspect 4: The torque measurement system of Aspect 2, wherein the first metamaterial array and the third metamaterial array are interleaved or intermixed, and wherein the second metamaterial array and the fourth metamaterial array are interleaved or intermixed.

Aspect 5: The torque measurement system of Aspect 4, wherein the first elementary structures and second elementary structures have a first structure size, and the third elementary structures and the fourth elementary structures have a second structure size that is different from the first structure size.

Aspect 6: The torque measurement system of Aspect 2, wherein the first pair of metamaterial arrays are arranged at a first radial distance from the rotational shaft, and wherein the second pair of metamaterial arrays are arranged at a second radial distance from the rotational shaft that is less than the first radial distance.

Aspect 7: The torque measurement system of Aspect 6, wherein the first elementary structures, the second elementary structures, the third elementary structures, and the fourth elementary structures have a same structure size.

Aspect 8: The torque measurement system of Aspect 1, wherein the first mutually coupled structure has a first resonance frequency and the second mutually coupled structure has a second resonance frequency, wherein the change in the first torque-dependent coupling causes the first resonance frequency to change by a first amount, and wherein the change in the second torque-dependent coupling causes the second resonance frequency to change by a second amount that is different from the first amount.

Aspect 9: The torque measurement system of Aspect 1, wherein the first torque-dependent coupling has first torque sensitivity, and wherein the second torque-dependent coupling has second torque sensitivity that is lower than the first torque sensitivity.

Aspect 10: The torque measurement system of Aspect 1, wherein the first torque-dependent coupling has a first unambiguous measurement range of applied torque, wherein the second torque-dependent coupling has a second unambiguous measurement range of applied torque that is different from the first unambiguous measurement range of applied torque.

Aspect 11: The torque measurement system of Aspect 1, further comprising: at least one transmitter configured to transmit a first electromagnetic transmit wave toward the first mutually coupled structure, and transmit a second electromagnetic transmit wave toward the second mutually coupled structure, wherein the first mutually coupled structure is configured to convert the first electromagnetic transmit wave into a first electromagnetic receive wave based on the first rotational shift, and wherein the second mutually coupled structure is configured to convert the second electromagnetic transmit wave into a second electromagnetic receive wave based on the second rotational shift; and at least one receiver configured to receive the first electromagnetic receive wave and the second electromagnetic receive wave, monitor a first measurement of the first electromagnetic receive wave, and compare the first measurement to a torque threshold, wherein the at least one receiver is configured to, based on the first measurement not satisfying the torque threshold, determine the torque applied to the rotational shaft based on the first measurement, and wherein the at least one receiver is configured to, based on the first measurement satisfying the torque threshold, determine the torque applied to the rotational shaft based on a second measurement of the second electromagnetic receive wave.

Aspect 12: The torque measurement system of Aspect 1, further comprising: at least one transmitter configured to transmit a first electromagnetic transmit wave toward the first mutually coupled structure, and transmit a second electromagnetic transmit wave toward the second mutually coupled structure, wherein the first mutually coupled structure is configured to convert the first electromagnetic transmit wave into a first electromagnetic receive wave based on the first rotational shift, and wherein the second mutually coupled structure is configured to convert the second electromagnetic transmit wave into a second electromagnetic receive wave based on the second rotational shift; and at least one receiver configured to receive the first electromagnetic receive wave and the second electromagnetic receive wave, and determine the torque applied to the rotational shaft based on a first measurement of the first electromagnetic receive wave and based on a second measurement of the second electromagnetic receive wave.

Aspect 13: The torque measurement system of Aspect 11, wherein the first mutually coupled structure is configured to modify the first electromagnetic transmit wave based on the first torque-dependent coupling, thereby producing the first electromagnetic receive wave, the first electromagnetic receive wave having a first parameter value based on the torque applied to the rotational shaft, and wherein the second mutually coupled structure is configured to modify the second electromagnetic transmit wave based on the second torque-dependent coupling, thereby producing the second electromagnetic receive wave, the second electromagnetic receive wave having a second parameter value based on the torque applied to the rotational shaft.

Aspect 14: The torque measurement system of Aspect 1, further comprising: at least one transmitter configured to transmit an electromagnetic transmit wave toward the first mutually coupled structure and the second mutually coupled structure, wherein the first mutually coupled structure is configured to convert the electromagnetic transmit wave into a first electromagnetic receive wave based on the first rotational shift, and the second mutually coupled structure is configured to convert the electromagnetic transmit wave into a second electromagnetic receive wave based on the second rotational shift; and at least one receiver configured to receive the first electromagnetic receive wave and the second electromagnetic receive wave, monitor a first measurement of the first electromagnetic receive wave, and compare the first measurement to a torque threshold, wherein the at least one receiver is configured to, based on the first measurement not satisfying the torque threshold, determine the torque applied to the rotational shaft based on the first measurement, and wherein the at least one receiver is configured to, based on the first measurement satisfying the torque threshold, determine the torque applied to the rotational shaft based on a second measurement of the second electromagnetic receive wave.

Aspect 15: The torque measurement system of Aspect 1, further comprising: at least one transmitter configured to transmit an electromagnetic transmit wave toward the first mutually coupled structure and the second mutually coupled structure, wherein the first mutually coupled structure is configured to convert the electromagnetic transmit wave into a first electromagnetic receive wave based on the first rotational shift, and the second mutually coupled structure is configured to convert the electromagnetic transmit wave into a second electromagnetic receive wave based on the second rotational shift; and at least one receiver configured to receive the first electromagnetic receive wave and the second electromagnetic receive wave, and determine the torque applied to the rotational shaft based on a first measurement of the first electromagnetic receive wave and based on a second measurement of the second electromagnetic receive wave.

Aspect 16: The torque measurement system of Aspect 1, wherein the first torque-dependent coupling affects a first mm-wave property of the first mutually coupled structure such that the first mm-wave property changes based on the torque applied to the rotational shaft, and wherein the second torque-dependent coupling affects a second mm-wave property of the second mutually coupled structure such that the second mm-wave property changes based on the torque applied to the rotational shaft.

Aspect 17: A measurement system, comprising: a first metamaterial array coupled to a first carrier structure, the first metamaterial array comprising first elementary structures; a second metamaterial array coupled to a second carrier structure, the second metamaterial array comprising second elementary structures, wherein the first metamaterial array and the second metamaterial array are mutually coupled to each other by a first shift-dependent coupling, thereby forming a first mutually coupled structure; a third metamaterial array coupled to the first carrier structure, the third metamaterial array comprising third elementary structures; and a fourth metamaterial array coupled to the second carrier structure, the fourth metamaterial array comprising fourth elementary structures, wherein the third metamaterial array and the fourth metamaterial array are mutually coupled to each other by a second shift-dependent coupling, thereby forming a second mutually coupled structure, wherein the first carrier structure and the second carrier structure are configured to allow a relative shift between the first carrier structure and the second carrier structure such that the first metamaterial array and the second metamaterial array undergo a first positional shift relative to each other, and the third metamaterial array and the fourth metamaterial array undergo a second positional shift relative to each other, and wherein a change in the first shift-dependent coupling caused by the relative shift between the first carrier structure and the second carrier structure is different than a change in the second shift-dependent coupling caused by the relative shift between the first carrier structure and the second carrier structure.

Aspect 18: The measurement system of Aspect 17, wherein the first mutually coupled structure has a first resonance frequency and the second mutually coupled structure has a second resonance frequency, wherein the change in the first shift-dependent coupling causes the first resonance frequency to change by a first amount, and wherein the change in the second shift-dependent coupling causes the second resonance frequency to change by a second amount that is different from the first amount.

Aspect 19: The measurement system of any of Aspects 17-18, wherein the first shift-dependent coupling has first sensitivity to the relative shift, and wherein the second shift-dependent coupling has second sensitivity to the relative shift that is lower than the first sensitivity.

Aspect 20: The measurement system of Aspect 17, wherein the first shift-dependent coupling has a first unambiguous measurement range, and wherein the second shift-dependent coupling has a second unambiguous measurement range that is different from the first unambiguous measurement range.

Aspect 21: The measurement system of Aspect 17, further comprising: at least one transmitter configured to transmit a first electromagnetic transmit wave toward the first mutually coupled structure, and transmit a second electromagnetic transmit wave toward the second mutually coupled structure, wherein the first mutually coupled structure is configured to convert the first electromagnetic transmit wave into a first electromagnetic receive wave based on the first positional shift, and wherein the second mutually coupled structure is configured to convert the second electromagnetic transmit wave into a second electromagnetic receive wave based on the second positional shift; and at least one receiver configured to receive the first electromagnetic receive wave and the second electromagnetic receive wave, monitor a first measurement of the first electromagnetic receive wave, and compare the first measurement to a threshold, wherein the at least one receiver is configured to, based on the first measurement not satisfying the threshold, determine the relative shift based on the first measurement, and wherein the at least one receiver is configured to, based on the first measurement satisfying the threshold, determine the relative shift applied based on a second measurement of the second electromagnetic receive wave.

Aspect 22: The measurement system of Aspect 17, further comprising: at least one transmitter configured to transmit a first electromagnetic transmit wave toward the first mutually coupled structure, and transmit a second electromagnetic transmit wave toward the second mutually coupled structure, wherein the first mutually coupled structure is configured to convert the first electromagnetic transmit wave into a first electromagnetic receive wave based on the first positional shift, and wherein the second mutually coupled structure is configured to convert the second electromagnetic transmit wave into a second electromagnetic receive wave based on the second positional shift; and at least one receiver configured to receive the first electromagnetic receive wave and the second electromagnetic receive wave, and determine the relative shift based on a first measurement of the first electromagnetic receive wave and based on a second measurement of the second electromagnetic receive wave.

Aspect 23: The measurement system of Aspect 17, further comprising: at least one transmitter configured to transmit an electromagnetic transmit wave toward the first mutually coupled structure and the second mutually coupled structure, wherein the first mutually coupled structure is configured to convert the electromagnetic transmit wave into a first electromagnetic receive wave based on the first positional shift, and the second mutually coupled structure is configured to convert the electromagnetic transmit wave into a second electromagnetic receive wave based on the second positional shift; and at least one receiver configured to receive the first electromagnetic receive wave and the second electromagnetic receive wave, monitor a first measurement of the first electromagnetic receive wave, and compare the first measurement to a threshold, wherein the at least one receiver is configured to, based on the first measurement not satisfying the threshold, determine the relative shift applied based on the first measurement, and wherein the at least one receiver is configured to, based on the first measurement satisfying the threshold, determine the relative shift applied based on a second measurement of the second electromagnetic receive wave.

Aspect 24: The measurement system of Aspect 17, further comprising: at least one transmitter configured to transmit an electromagnetic transmit wave toward the first mutually coupled structure and the second mutually coupled structure, wherein the first mutually coupled structure is configured to convert the electromagnetic transmit wave into a first electromagnetic receive wave based on the first positional shift, and the second mutually coupled structure is configured to convert the electromagnetic transmit wave into a second electromagnetic receive wave based on the second positional shift; and at least one receiver configured to receive the first electromagnetic receive wave and the second electromagnetic receive wave, and determine the relative shift based on a first measurement of the first electromagnetic receive wave and based on a second measurement of the second electromagnetic receive wave.

Aspect 25: A method of determining a relative shift between a first carrier structure and a second carrier structure of a mechanical system, the method comprising: inducing a first positional shift between a first metamaterial array coupled to the first carrier structure and a second metamaterial array coupled to the second carrier structure in response to the relative shift between the first carrier structure and the second carrier structure inducing a second positional shift between a third metamaterial array coupled to the first carrier structure and a fourth metamaterial array coupled to the second carrier structure in response to the relative shift between the first carrier structure and the second carrier structure, wherein the first metamaterial array and the second metamaterial array are mutually coupled to each other by a first shift-dependent coupling, thereby forming a first mutually coupled structure, wherein the third metamaterial array and the fourth metamaterial array are mutually coupled to each other by a second shift-dependent coupling, thereby forming a second mutually coupled structure, and wherein a change in the first shift-dependent coupling caused by the relative shift between the first carrier structure and the second carrier structure is different than a change in the second shift-dependent coupling caused by the relative shift between the first carrier structure and the second carrier structure; transmitting at least one electromagnetic transmit wave during the relative shift to generate a first electromagnetic receive wave by the first mutually coupled structure and a second electromagnetic receive wave by the first mutually coupled structure; and determining the relative shift between the first carrier structure and the second carrier structure based on at least one of the first electromagnetic receive wave or the second electromagnetic receive wave.

Aspect 26: The method of Aspect 25, wherein the at least one electromagnetic transmit wave is a mm-wave.

Aspect 27: The method of any of Aspects 25-26, wherein the first shift-dependent coupling includes at least one of a capacitive near-field coupling, an inductive near-field coupling, a waveguide coupling, or a far-field coupling, and wherein the second shift-dependent coupling includes at least one of a capacitive near-field coupling, an inductive near-field coupling, a waveguide coupling, or a far-field coupling.

Aspect 28: A system configured to perform one or more operations recited in one or more of Aspects 1-27.

Aspect 29: An apparatus comprising means for performing one or more operations recited in one or more of Aspects 1-27.

Aspect 30: A non-transitory computer-readable medium storing a set of instructions, the set of instructions comprising one or more instructions that, when executed by a device, cause the device to perform one or more operations recited in one or more of Aspects 1-27.

Aspect 31: A computer program product comprising instructions or code for executing one or more operations recited in one or more of Aspects 1-27.

The foregoing disclosure provides illustration and description, but is not intended to be exhaustive or to limit the implementations to the precise form disclosed. Modifications and variations are possible in light of the above disclosure or may be acquired from practice of the implementations.

As used herein, the term component is intended to be broadly construed as hardware, firmware, or a combination of hardware and software. It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware can be designed to implement the systems and/or methods based on the description herein.

Any of the processing components may be implemented as a central processing unit (CPU) or other processor reading and executing a software program from a non-transitory computer-readable recording medium such as a hard disk or a semiconductor memory device. For example, instructions may be executed by one or more processors, such as one or more CPUs, DSPs, general-purpose microprocessors, application-specific integrated circuits (ASICs), field programmable logic arrays (FPLAs), programmable logic controller (PLC), or other equivalent integrated or discrete logic circuitry. Accordingly, the term “processor,” as used herein refers to any of the foregoing structures or any other structure suitable for implementation of the techniques described herein. Software may be stored on a non-transitory computer-readable medium such that the non-transitory computer readable medium includes a program code or a program algorithm stored thereon which, when executed, causes the processor, via a computer program, to perform the steps of a method.

A controller including hardware may also perform one or more of the techniques of this disclosure. A controller, including one or more processors, may use electrical signals and digital algorithms to perform its receptive, analytic, and control functions, which may further include corrective functions. Such hardware, software, and firmware may be implemented within the same device or within separate devices to support the various techniques described in this disclosure.

A signal processing circuit and/or a signal conditioning circuit may receive one or more signals (e.g., measurement signals) from one or more components in the form of raw measurement data and may derive, from the measurement signal further information. Signal conditioning, as used herein, refers to manipulating an analog signal in such a way that the signal meets the requirements of a next stage for further processing. Signal conditioning may include converting from analog to digital (e.g., via an analog-to-digital converter), amplification, filtering, converting, biasing, range matching, isolation and any other processes required to make a signal suitable for processing after conditioning.

Some implementations may be described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, or the like.

Even though particular combinations of features are recited in the claims and/or disclosed in the specification, these combinations are not intended to limit the disclosure of implementations described herein. Many of these features may be combined in ways not specifically recited in the claims and/or disclosed in the specification. For example, the disclosure includes each dependent claim in a claim set in combination with every other individual claim in that claim set and every combination of multiple claims in that claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

Further, it is to be understood that the disclosure of multiple acts or functions disclosed in the specification or in the claims may not be construed as to be within the specific order. Therefore, the disclosure of multiple acts or functions will not limit these to a particular order unless such acts or functions are not interchangeable for technical reasons. Furthermore, in some implementations, a single act may include or may be broken into multiple sub acts. Such sub acts may be included and part of the disclosure of this single act unless explicitly excluded.

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Where only one item is intended, the phrase “only one,” “single,” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. As used herein, the term “multiple” can be replaced with “a plurality of” and vice versa. Also, as used herein, the term “or” is intended to be inclusive when used in a series and may be used interchangeably with “and/or,” unless explicitly stated otherwise (e.g., if used in combination with “either” or “only one of”).

What is claimed is:

1. A torque measurement system, comprising:
a first pair of metamaterial arrays arranged at least partially around a rotational axis of a rotational shaft, wherein the first pair of metamaterial arrays are coupled to the rotational shaft and are configured to rotate about the rotational axis, wherein metamaterial arrays of the first pair of metamaterial arrays are mutually coupled to each other by a first torque-dependent coupling, thereby forming a first mutually coupled structure; and
a second pair of metamaterial arrays arranged at least partially around the rotational axis of the rotational shaft, wherein the second pair of metamaterial arrays are coupled to the rotational shaft and are configured to rotate about the rotational axis, wherein metamaterial arrays of the second pair of metamaterial arrays are mutually coupled to each other by a second torque-dependent coupling, thereby forming a second mutually coupled structure,
wherein, in response to a torque applied to the rotational shaft, the metamaterial arrays of the first pair of metamaterial arrays are configured to undergo a first rotational shift relative to each other, and the metamaterial arrays of the second pair of metamaterial arrays are configured to undergo a second rotational shift relative to each other, and
wherein a change in the first torque-dependent coupling caused by the torque is different than a change in the second torque-dependent coupling caused by the torque.

2. The torque measurement system of claim 1, wherein the first pair of metamaterial arrays includes a first metamaterial array of first elementary structures and a second metamaterial array of second elementary structures, wherein the second metamaterial array is spaced apart from the first metamaterial array in an axial direction of the rotational shaft,
wherein the second pair of metamaterial arrays includes a third metamaterial array of third elementary structures and a fourth metamaterial array of fourth elementary structures, wherein the fourth metamaterial array is spaced apart from the third metamaterial array in the axial direction of the rotational shaft, and
wherein, in response to the torque applied to the rotational shaft, the first metamaterial array is configured to undergo the first rotational shift relative to the second metamaterial array, and the third metamaterial array is configured to undergo the second rotational shift relative to the fourth metamaterial array.

3. The torque measurement system of claim 2, wherein, in response to the torque applied to the rotational shaft, the first metamaterial array and the second metamaterial array are configured to rotate about the rotational axis by differing amounts of rotation, causing the first rotational shift and resulting in a first torque-dependent change to the first torque-dependent coupling, and
wherein, in response to the torque applied to the rotational shaft, the third metamaterial array and the fourth metamaterial array are configured to rotate about the rotational axis by differing amounts of rotation, causing the second rotational shift and resulting in a second torque-dependent change to the second torque-dependent coupling.

4. The torque measurement system of claim 2, wherein the first metamaterial array and the third metamaterial array are interleaved or intermixed, and
wherein the second metamaterial array and the fourth metamaterial array are interleaved or intermixed.

5. The torque measurement system of claim 4, wherein the first elementary structures and second elementary structures have a first structure size, and the third elementary structures and the fourth elementary structures have a second structure size that is different from the first structure size.

6. The torque measurement system of claim 2, wherein the first pair of metamaterial arrays are arranged at a first radial distance from the rotational shaft, and
wherein the second pair of metamaterial arrays are arranged at a second radial distance from the rotational shaft that is less than the first radial distance.

7. The torque measurement system of claim 6, wherein the first elementary structures, the second elementary structures, the third elementary structures, and the fourth elementary structures have a same structure size.

8. The torque measurement system of claim 1, wherein the first mutually coupled structure has a first resonance frequency and the second mutually coupled structure has a second resonance frequency,
wherein the change in the first torque-dependent coupling causes the first resonance frequency to change by a first amount, and
wherein the change in the second torque-dependent coupling causes the second resonance frequency to change by a second amount that is different from the first amount.

9. The torque measurement system of claim 1, wherein the first torque-dependent coupling has first torque sensitivity, and wherein the second torque-dependent coupling has second torque sensitivity that is lower than the first torque sensitivity.

10. The torque measurement system of claim 1, wherein the first torque-dependent coupling has a first unambiguous measurement range of applied torque,
wherein the second torque-dependent coupling has a second unambiguous measurement range of applied torque that is different from the first unambiguous measurement range of applied torque.

11. The torque measurement system of claim 1, further comprising:
at least one transmitter configured to transmit a first electromagnetic transmit wave toward the first mutually coupled structure, and transmit a second electromagnetic transmit wave toward the second mutually coupled structure,
wherein the first mutually coupled structure is configured to convert the first electromagnetic transmit wave into a first electromagnetic receive wave based on the first rotational shift, and
wherein the second mutually coupled structure is configured to convert the second electromagnetic transmit wave into a second electromagnetic receive wave based on the second rotational shift; and
at least one receiver configured to receive the first electromagnetic receive wave and the second electromagnetic receive wave, monitor a first measurement of the first electromagnetic receive wave, and compare the first measurement to a torque threshold,
wherein the at least one receiver is configured to, based on the first measurement not satisfying the torque threshold, determine the torque applied to the rotational shaft based on the first measurement, and
wherein the at least one receiver is configured to, based on the first measurement satisfying the torque threshold, determine the torque applied to the rotational shaft based on a second measurement of the second electromagnetic receive wave.

12. The torque measurement system of claim 1, further comprising:
at least one transmitter configured to transmit a first electromagnetic transmit wave toward the first mutually coupled structure, and transmit a second electromagnetic transmit wave toward the second mutually coupled structure,
wherein the first mutually coupled structure is configured to convert the first electromagnetic transmit wave into a first electromagnetic receive wave based on the first rotational shift, and
wherein the second mutually coupled structure is configured to convert the second electromagnetic transmit wave into a second electromagnetic receive wave based on the second rotational shift; and
at least one receiver configured to receive the first electromagnetic receive wave and the second electromagnetic receive wave, and determine the torque applied to the rotational shaft based on a first measurement of the first electromagnetic receive wave and based on a second measurement of the second electromagnetic receive wave.

13. The torque measurement system of claim 11, wherein the first mutually coupled structure is configured to modify the first electromagnetic transmit wave based on the first torque-dependent coupling, thereby producing the first electromagnetic receive wave, the first electromagnetic receive wave having a first parameter value based on the torque applied to the rotational shaft, and
wherein the second mutually coupled structure is configured to modify the second electromagnetic transmit wave based on the second torque-dependent coupling, thereby producing the second electromagnetic receive wave, the second electromagnetic receive wave having a second parameter value based on the torque applied to the rotational shaft.

14. The torque measurement system of claim 1, further comprising:
at least one transmitter configured to transmit an electromagnetic transmit wave toward the first mutually coupled structure and the second mutually coupled structure, wherein the first mutually coupled structure is configured to convert the electromagnetic transmit wave into a first electromagnetic receive wave based on the first rotational shift, and the second mutually coupled structure is configured to convert the electromagnetic transmit wave into a second electromagnetic receive wave based on the second rotational shift; and
at least one receiver configured to receive the first electromagnetic receive wave and the second electromagnetic receive wave, monitor a first measurement of the first electromagnetic receive wave, and compare the first measurement to a torque threshold,
wherein the at least one receiver is configured to, based on the first measurement not satisfying the torque threshold, determine the torque applied to the rotational shaft based on the first measurement, and
wherein the at least one receiver is configured to, based on the first measurement satisfying the torque threshold, determine the torque applied to the rotational shaft based on a second measurement of the second electromagnetic receive wave.

15. The torque measurement system of claim 1, further comprising:
at least one transmitter configured to transmit an electromagnetic transmit wave toward the first mutually coupled structure and the second mutually coupled structure, wherein the first mutually coupled structure is configured to convert the electromagnetic transmit wave into a first electromagnetic receive wave based on the first rotational shift, and the second mutually coupled structure is configured to convert the electromagnetic transmit wave into a second electromagnetic receive wave based on the second rotational shift; and
at least one receiver configured to receive the first electromagnetic receive wave and the second electromagnetic receive wave, and determine the torque applied to the rotational shaft based on a first measurement of the first electromagnetic receive wave and based on a second measurement of the second electromagnetic receive wave.

16. The torque measurement system of claim 1, wherein the first torque-dependent coupling affects a first millimeter (mm)-wave property of the first mutually coupled structure such that the first mm-wave property changes based on the torque applied to the rotational shaft, and
wherein the second torque-dependent coupling affects a second mm-wave property of the second mutually coupled structure such that the second mm-wave property changes based on the torque applied to the rotational shaft.

17. A measurement system, comprising:
a first metamaterial array coupled to a first carrier structure, the first metamaterial array comprising first elementary structures;
a second metamaterial array coupled to a second carrier structure, the second metamaterial array comprising second elementary structures, wherein the first metamaterial array and the second metamaterial array are mutually coupled to each other by a first shift-dependent coupling, thereby forming a first mutually coupled structure;
a third metamaterial array coupled to the first carrier structure, the third metamaterial array comprising third elementary structures; and
a fourth metamaterial array coupled to the second carrier structure, the fourth metamaterial array comprising fourth elementary structures, wherein the third metamaterial array and the fourth metamaterial array are mutually coupled to each other by a second shift-dependent coupling, thereby forming a second mutually coupled structure,
wherein the first carrier structure and the second carrier structure are configured to allow a relative shift between the first carrier structure and the second carrier structure such that the first metamaterial array and the second metamaterial array undergo a first positional shift relative to each other, and the third metamaterial array and the fourth metamaterial array undergo a second positional shift relative to each other, and
wherein a change in the first shift-dependent coupling caused by the relative shift between the first carrier structure and the second carrier structure is different than a change in the second shift-dependent coupling caused by the relative shift between the first carrier structure and the second carrier structure.

18. The measurement system of claim 17, wherein the first mutually coupled structure has a first resonance frequency and the second mutually coupled structure has a second resonance frequency,
wherein the change in the first shift-dependent coupling causes the first resonance frequency to change by a first amount, and
wherein the change in the second shift-dependent coupling causes the second resonance frequency to change by a second amount that is different from the first amount.

19. The measurement system of claim 17, wherein the first shift-dependent coupling has first sensitivity to the relative shift, and wherein the second shift-dependent coupling has second sensitivity to the relative shift that is lower than the first sensitivity.

20. The measurement system of claim 17, wherein the first shift-dependent coupling has a first unambiguous measurement range, and
wherein the second shift-dependent coupling has a second unambiguous measurement range that is different from the first unambiguous measurement range.

21. The measurement system of claim 17, further comprising:
at least one transmitter configured to transmit a first electromagnetic transmit wave toward the first mutually coupled structure, and transmit a second electromagnetic transmit wave toward the second mutually coupled structure,
wherein the first mutually coupled structure is configured to convert the first electromagnetic transmit wave into a first electromagnetic receive wave based on the first positional shift, and
wherein the second mutually coupled structure is configured to convert the second electromagnetic transmit wave into a second electromagnetic receive wave based on the second positional shift; and
at least one receiver configured to receive the first electromagnetic receive wave and the second electromagnetic receive wave, monitor a first measurement of the first electromagnetic receive wave, and compare the first measurement to a threshold,
wherein the at least one receiver is configured to, based on the first measurement not satisfying the threshold, determine the relative shift based on the first measurement, and
wherein the at least one receiver is configured to, based on the first measurement satisfying the threshold, determine the relative shift applied based on a second measurement of the second electromagnetic receive wave.

22. The measurement system of claim 17, further comprising:
at least one transmitter configured to transmit a first electromagnetic transmit wave toward the first mutually coupled structure, and transmit a second electromagnetic transmit wave toward the second mutually coupled structure,
wherein the first mutually coupled structure is configured to convert the first electromagnetic transmit wave into a first electromagnetic receive wave based on the first positional shift, and
wherein the second mutually coupled structure is configured to convert the second electromagnetic transmit wave into a second electromagnetic receive wave based on the second positional shift; and
at least one receiver configured to receive the first electromagnetic receive wave and the second electromagnetic receive wave, and determine the relative shift based on a first measurement of the first electromagnetic receive wave and based on a second measurement of the second electromagnetic receive wave.

23. The measurement system of claim 17, further comprising:
at least one transmitter configured to transmit an electromagnetic transmit wave toward the first mutually coupled structure and the second mutually coupled structure, wherein the first mutually coupled structure is configured to convert the electromagnetic transmit wave into a first electromagnetic receive wave based on the first positional shift, and the second mutually coupled structure is configured to convert the electromagnetic transmit wave into a second electromagnetic receive wave based on the second positional shift; and
at least one receiver configured to receive the first electromagnetic receive wave and the second electromagnetic receive wave, monitor a first measurement of the first electromagnetic receive wave, and compare the first measurement to a threshold,
wherein the at least one receiver is configured to, based on the first measurement not satisfying the threshold, determine the relative shift applied based on the first measurement, and
wherein the at least one receiver is configured to, based on the first measurement satisfying the threshold, determine the relative shift applied based on a second measurement of the second electromagnetic receive wave.

24. The measurement system of claim 17, further comprising:
at least one transmitter configured to transmit an electromagnetic transmit wave toward the first mutually coupled structure and the second mutually coupled structure, wherein the first mutually coupled structure is configured to convert the electromagnetic transmit wave into a first electromagnetic receive wave based on the first positional shift, and the second mutually coupled structure is configured to convert the electromagnetic transmit wave into a second electromagnetic receive wave based on the second positional shift; and
at least one receiver configured to receive the first electromagnetic receive wave and the second electromagnetic receive wave, and determine the relative shift based on a first measurement of the first electromagnetic receive wave and based on a second measurement of the second electromagnetic receive wave.

25. A method of determining a relative shift between a first carrier structure and a second carrier structure of a mechanical system, the method comprising:
inducing a first positional shift between a first metamaterial array coupled to the first carrier structure and a second metamaterial array coupled to the second carrier structure in response to the relative shift between the first carrier structure and the second carrier structure
inducing a second positional shift between a third metamaterial array coupled to the first carrier structure and a fourth metamaterial array coupled to the second carrier structure in response to the relative shift between the first carrier structure and the second carrier structure,
wherein the first metamaterial array and the second metamaterial array are mutually coupled to each other by a first shift-dependent coupling, thereby forming a first mutually coupled structure,
wherein the third metamaterial array and the fourth metamaterial array are mutually coupled to each other by a second shift-dependent coupling, thereby forming a second mutually coupled structure, and
wherein a change in the first shift-dependent coupling caused by the relative shift between the first carrier structure and the second carrier structure is different than a change in the second shift-dependent coupling caused by the relative shift between the first carrier structure and the second carrier structure;
transmitting at least one electromagnetic transmit wave during the relative shift to generate a first electromagnetic receive wave by the first mutually coupled structure and a second electromagnetic receive wave by the first mutually coupled structure; and
determining the relative shift between the first carrier structure and the second carrier structure based on at least one of the first electromagnetic receive wave or the second electromagnetic receive wave.

26. The method of claim 25, wherein the at least one electromagnetic transmit wave is a millimeter (mm)-wave.

27. The method of claim 25, wherein the first shift-dependent coupling includes at least one of a capacitive near-field coupling, an inductive near-field coupling, a waveguide coupling, or a far-field coupling, and
wherein the second shift-dependent coupling includes at least one of a capacitive near-field coupling, an inductive near-field coupling, a waveguide coupling, or a far-field coupling.
